(19) United States
(12) Patent Application Publication
(10) Pub. No.: US 2017/0038574 A1
(43) Pub. Date: Feb. 9, 2017

(54) THREE-DIMENSIONAL SUPER-RESOLUTION FLUORESCENCE IMAGING USING AIRY BEAMS AND OTHER TECHNIQUES

(71) Applicant: President and Fellows of Harvard College, Cambridge, MA (US)

(72) Inventors: Xiaowei Zhuang, Lexington, MA (US); Shu Jia, Boston, MA (US)

(21) Appl. No.: 15/116,062

(22) PCT Filed: Feb. 3, 2015
(86) PCT No.: PCT/US15/14206

§ 371 Date: Aug. 2, 2016

Related U.S. Application Data
(60) Provisional application No. 61/934,928, filed on Feb. 3, 2014.
(60) Provisional application No. 61/938,089, filed on Feb. 10, 2014.

(51) Int. Cl. G02B 21/00; G02B 27/58; G02B 21/36; G01N 21/64; G02B 27/28; G02B 27/00

(52) U.S. Cl. CPC G02B 21/0076; G02B 21/0068; G02B 27/283; G02B 27/0068; G02B 21/367; G01N 21/6458; G02B 27/58

(57) ABSTRACT

The present invention generally relates to super-resolution imaging and other imaging techniques, including imaging in three dimensions. In one aspect, light from emissive entities in a sample may be used to produce polarized beams of light, which can be altered to produce Airy beams. Airy beams can maintain their intensity profiles over large distances without substantial diffraction, according to certain embodiments of the invention. For example, such beams can be used to determine the position of an emissive entity within a sample, and in some embodiments, in 3 dimensions; in some cases, the position may be determined at relatively high resolutions in all 3 dimensions.

### RELATED APPLICATIONS

This application claims the benefit of U.S. Provisional Patent Application Ser. No. 61/934,928, filed Feb. 3, 2014, entitled “Three-Dimensional Super-Resolution Fluorescence Imaging Using Point Spread Functions and Other Techniques”; and of U.S. Provisional Patent Application Ser. No. 61/938,089, filed Feb. 10, 2014, entitled “Three-Dimensional Super-Resolution Fluorescence Imaging Using Point Spread Functions and Other Techniques,” each of which is incorporated herein by reference in its entirety.

### GOVERNMENT FUNDING

Research leading to various aspects of the present invention was sponsored, at least in part, by the National Institutes of Health, Grant No. GM068518. The U.S. Government has certain rights in the invention.

### FIELD

The present invention generally relates to super-resolution imaging and other imaging techniques, including imaging in three dimensions.

### BACKGROUND

Recent years have witnessed the emergence of super-resolution fluorescence imaging techniques which surpass the optical diffraction limit and allow fluorescence imaging with near-molecular-scale resolution. These techniques include approaches that use spatially patterned illumination to control the emitting states of molecules in a spatially targeted manner, or methods that are based on stochastic switching of individual molecules. Among these techniques, the stochastic switching methods, such as stochastic optical reconstruction microscopy (STORM), rely on stochastic activation and precise localization of single molecules to reconstruct fluorescence images with sub-diffraction-limit resolution. See, e.g., U.S. Pat. No. 7,838,302, issued Nov. 23, 2010, entitled “Sub-Diffraction Limit Image Resolution and Other Imaging Techniques,” by Zhuang, et al., incorporated herein by reference.

Various strategies have been used to localize individual fluorescent molecules for three-dimensional (3D) super-resolution imaging, but these strategies often suffer from either anisotropic image resolution with substantially poorer resolution in the direction along the optical axis, or a limited depth of focus, e.g., less than one micron. While it is possible to increase the imaging depth by scanning the focal plane, photobleaching of the out-of-focus fluorophores prior to their imaging and localization substantially compromises the image quality.

### SUMMARY

The present invention generally relates to super-resolution imaging and other imaging techniques, including imaging in three dimensions. The subject matter of the present invention involves, in some cases, interrelated products, alternative solutions to a particular problem, and/or a plurality of different uses of one or more systems and/or articles.

In one aspect, the present invention is generally directed to a system for microscopy. According to one set of embodiments, the system for microscopy comprises an illumination system comprising an excitation light source directed at a sample region, a spatial light modulator for altering light produced by an emissive entity in the sample region to produce an Airy beam, a detector for receiving light altered by the spatial light modulator; and a controller for controlling light produced by the illumination system, wherein the controller is able to repeatedly or continuously expose the sample region to excitation light from the excitation light source.

The system for microscopy, in another set of embodiments, comprises an illumination system comprising an excitation light source directed at a sample region, a spatial light modulator for altering light produced by an emissive entity in the sample region to produce one or more light beams, wherein the position of the light beams depends on propagation distance, a detector for receiving light altered by the spatial light modulator, and a controller for controlling light produced by the illumination system. In some embodiments, the controller is able to repeatedly or continuously expose the sample region to excitation light from the excitation light source.

In yet another set of embodiments, the system for microscopy includes an illumination system comprising an activation light source and an excitation light source, each directed at a sample region, a spatial light modulator for altering light produced by an emissive entity in the sample region to produce a non-diffracting beam of light, and a detector for receiving light altered by the spatial light modulator.

The system for microscopy, in still another set of embodiments, includes an illumination system comprising an excitation light source directed at a sample region, a device for altering light produced by an emissive entity in the sample region to produce an Airy beam, a detector for receiving light altered by the spatial light modulator; and a controller for controlling light produced by the illumination system, wherein the controller is able to repeatedly or continuously expose the sample region to excitation light from the excitation light source.

The system for microscopy, in yet another set of embodiments, comprises an illumination system comprising an activation light source and an excitation light source, each directed at a sample region, a device for altering light produced by an emissive entity in the sample region to produce a non-diffracting beam of light, and a detector for receiving light altered by the spatial light modulator.

The system for microscopy, in still another set of embodiments, comprises an illumination system comprising an activation light source and an excitation light source, each directed at a sample region, a device for altering light produced by an emissive entity in the sample region to produce an emission light beam, wherein the position of the emission light beam depends on propagation distance; and a detector for receiving light altered by the spatial light modulator.

In one set of embodiments, the system for microscopy comprises an illumination system comprising an excitation light source directed at a sample region, a polarizing beam splitter for altering light produced by an emissive entity in the sample region to produce polarized light, a spatial light modulator for altering the polarized light, a detector for receiving light altered by the spatial light modulator, and a controller for controlling light produced by the illumination system, wherein the controller is able to repeatedly expose the sample region to excitation light from the excitation light source.

In another set of embodiments, the system for microscopy comprises an illumination system comprising an activation light source and an excitation light source, each directed at a sample region, a polarizing beam splitter for altering light produced by an emissive entity in the sample region to produce polarized light, a spatial light modulator for altering light produced by an emissive entity in the sample region, and a detector for receiving light altered by the spatial light modulator.

Still another set of embodiments is generally directed to a system for microscopy comprising an illumination system comprising an excitation light source directed at a sample region, a spatial light modulator for altering light produced by an emissive entity in the sample region to produce an Airy beam, a detector for receiving light altered by the spatial light modulator, and a controller for controlling light produced by the illumination system. In some cases, the controller is able to repeatedly expose the sample region to excitation light from the excitation light source.

Yet another set of embodiments is generally directed to a system for microscopy comprising an illumination system comprising an activation light source and an excitation light source, each directed at a sample region, a spatial light modulator for altering light produced by an emissive entity in the sample region to produce an Airy beam, and a detector for receiving light altered by the spatial light modulator.

In another set of embodiments, the system comprises an illumination system comprising an excitation light source directed at a sample region, a spatial light modulator for altering light produced by an emissive entity in the sample region to produce a non-diffracting beam of light, a detector for receiving light altered by the spatial light modulator, and a controller for controlling light produced by the illumination system. In some instances, the controller is able to repeatedly expose the sample region to excitation light from the excitation light source. The system for microscopy, in yet another set of embodiments, comprises an illumination system comprising an activation light source and an excitation light source, each directed at a sample region, a spatial light modulator for altering light produced by an emissive entity in the sample region to produce a non-diffracting beam of light, and a detector for receiving light altered by the spatial light modulator.

In one set of embodiments, the system for microscopy comprises an illumination system comprising an excitation light source directed at a sample region, a spatial light modulator for altering light produced by an emissive entity in the sample region to produce one or more light beams, where the light beams bend as they propagate and the positions of the light beams depends on propagation distance, a detector for receiving light altered by the spatial light modulator, and a controller for controlling light produced by the illumination system, wherein the controller is able to repeatedly or continuously expose the sample region to excitation light from the excitation light source.

The system for microscopy, in another set of embodiments, comprises an illumination system comprising an activation light source and an excitation light source, each directed at a sample region, a device for altering light produced by an emissive entity in the sample region to produce an emission light beam, where the light beam bends as it propagates and the position of the emission light beam depends on propagation distance, and a detector for receiving light altered by the spatial light modulator.

In another aspect, the present invention is generally directed to an imaging method. According to one set of embodiments, the imaging method comprises acts of converting light emitted by emissive entities in a sample into one or more Airy beams, acquiring one or more images of the one or more Airy beams, and determining the position of at least some of the emissive entities within the sample based on the one or more images.

The imaging method, in another set of embodiments, comprises acts of converting light emitted by emissive entities in a sample to produce one or more light beams, where the position of the light beams depends on propagation distance, acquiring one or more images of the light beams, and determining the position of at least some of the emissive entities within the sample based on the one or more images.

In yet another set of embodiments, the imaging method includes acts of converting light emitted by emissive entities in a sample into a non-diffracting beam, acquiring one or more images of the non-diffracting beam, and determining the position of at least some of the emissive entities within the sample based on the one or more images.

The imaging method, in still another set of embodiments, includes acts of splitting light emitted by an emissive entity in a sample to produce two polarization beams, altering phasing within at least one of the two polarization beams, acquiring one or more images of the two polarization beams, and determining the position of the emissive entity within the sample based on the image.

In another set of embodiments, the imaging method comprises acts of splitting light emitted by a photoswitchable entity in a sample to produce two polarization beams, altering phasing within at least one of the two polarization beams, and acquiring one or more images of the two polarization beams.

In yet another set of embodiments, the imaging method includes acts of polarizing light emitted by an emissive entity in a sample, directing the polarized light at a spatial light modulator, acquiring one or more images of the modulated light, and determining the position of the emissive entity within the sample based on the image.

According to still another set of embodiments, the imaging method includes acts of polarizing light emitted by a photoswitchable entity in a sample, directing the polarized light at a spatial light modulator, and acquiring one or more images of the modulated light.

In one set of embodiments, the imaging method comprises acts of providing light emitted by an emissive entity in a sample, altering the emitted light to produce an Airy beam, acquiring one or more images of the Airy beam, and determining the position of the emissive entity within the sample based on the image.

The imaging method, in another set of embodiments, includes acts of providing light emitted by a photoswitchable entity in a sample, altering the emitted light to produce an Airy beam, and acquiring one or more images of the Airy beam.

In yet another set of embodiments, the imaging method includes acts of providing light emitted by an emissive entity in a sample, altering the emitted light to produce a non-diffracting beam of light, acquiring one or more images of the non-diffracting beam of light, and determining the position of the emissive entity within the sample based on the image.

The imaging method, in still another set of embodiments, is directed to acts of providing light emitted by a photoswitchable entity in a sample, altering the emitted light to produce a non-diffracting beam of light, and acquiring one or more images of the non-diffracting beam of light.

In yet another embodiment, the imaging method includes acts of converting light emitted by emissive entities in a sample to produce one or more light beams, where the light beams bend as they propagate and the positions of the light beams depends on propagation distance, acquiring one or more images of the light beams, and determining the position of at least some of the emissive entities within the sample based on the one or more images.

In another aspect, the present invention encompasses methods of making one or more of the embodiments described herein. In still another aspect, the present invention encompasses methods of using one or more of the embodiments described herein.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIGS. 1A-1F illustrate systems and methods generally directed to a self-bending point spread function based on an Airy beam, according to certain embodiments of the invention;

FIGS. 2A-2B illustrate localization precision of molecules, in another embodiment of the invention

FIGS. 3A-3D illustrate imaging of microtubules, in another embodiment of the invention;

FIGS. 4A-4G illustrate imaging of microtubules and mitochondria, in yet another embodiment of the invention;

FIG. 5 illustrates an optical set-up in accordance with still another embodiment of the invention;

FIG. 6 illustrates a phase pattern in yet another embodiment of the invention;

FIGS. 7A-7B illustrate measured transverse profiles in one embodiment of the invention;

FIGS. 8A-8J illustrate imaging of microtubules in another embodiment of the invention; and

FIGS. 9A-9E illustrate calibration and alignment in certain embodiments of the invention.

### DETAILED DESCRIPTION

The present invention generally relates to super-resolution imaging and other imaging techniques, including imaging in three dimensions. In one aspect, light from emissive entities in a sample may be used to produce polarized beams of light, which can be altered to produce Airy beams. Airy beams can maintain their intensity profiles over large distances without substantial diffraction, according to certain embodiments of the invention. For example, such beams can be used to determine the position of an emissive entity within a sample, and in some embodiments, in 3 dimensions; in some cases, the position may be determined at relatively high resolutions in all 3 dimensions.

According to some embodiments, light from an emissive entity may be used to produce two orthogonally polarized beams of light, which can be altered to produce Airy beams. Differences in the lateral (x or y) position of the entity in images of the two Airy beams may be used to determine the z position of the entity within the sample. In addition, in some cases, techniques such as these may be combined with various stochastic imaging techniques.

In one aspect, the present invention is generally directed to microscopy systems, especially optical microscopy systems, for acquiring images at super-resolutions, or resolutions that are smaller than the theoretical Abbe diffraction limit of light. Other examples of suitable microscopy systems include, but are not limited to, confocal microscopy systems or two-photon microscopy systems. In certain embodiments of the invention, as discussed below, surprisingly isotropic or high (small) resolutions may be obtained using such techniques, for example, resolutions of about 20 nm in three dimensions. One example of an embodiment of the invention is now described with respect to

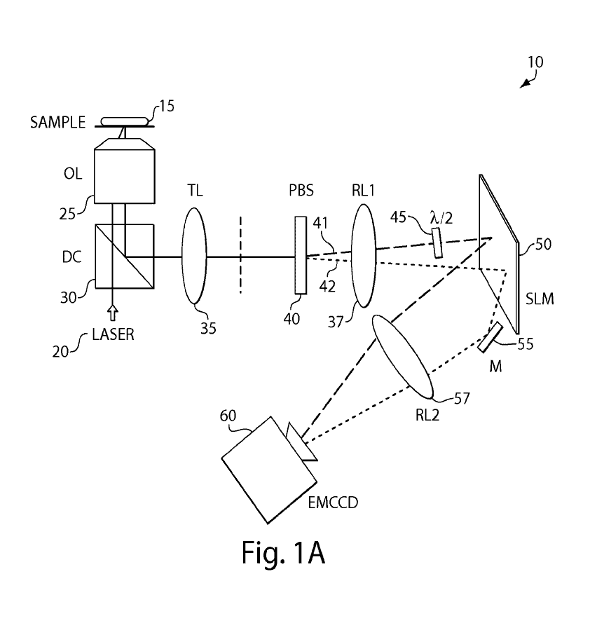

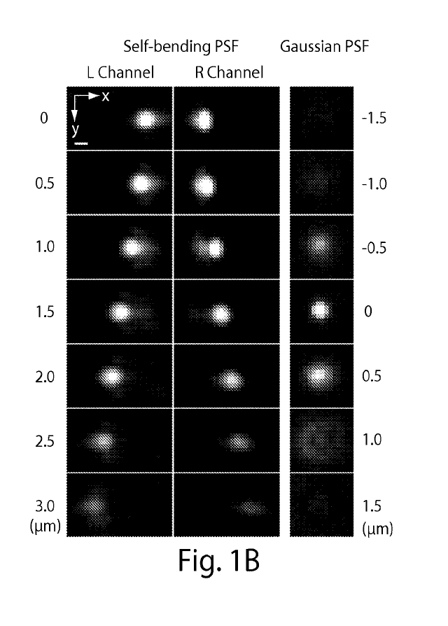

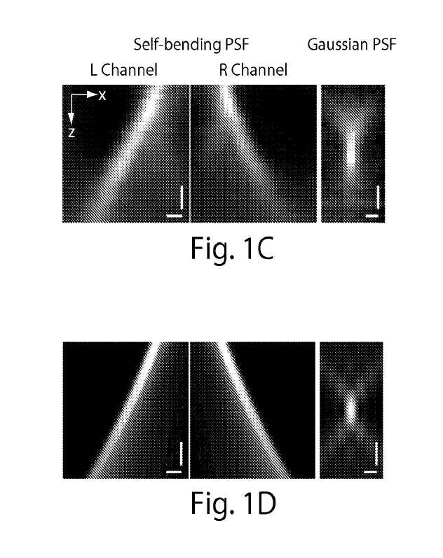

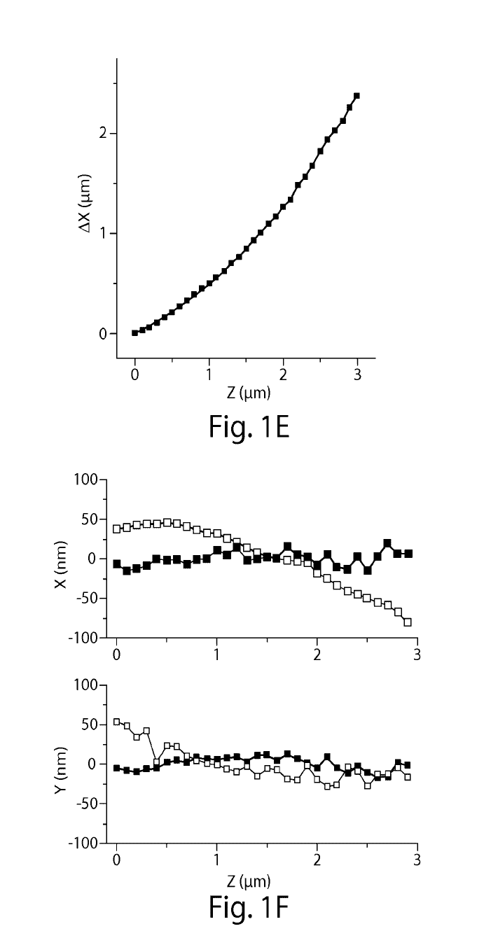

FIG. 1A. As will be discussed in more detail below, in other embodiments, other configurations may be used as well. In this figure, microscopy system 10 includes a sample 15 within a sample region. Microscopy system 10 also includes an illumination system, e.g., comprising a laser (or other monochromatic light source) 20 directed towards the sample region. The illumination system may contain other light sources as well in certain embodiments, e.g., an activation light source for use in certain applications such as STORM or other stochastic imaging techniques as discussed herein. See, e.g., International Patent Application No. PCT/U52008/013915, filed Dec. 19, 2008, entitled “Sub-diffraction Limit Image Resolution in Three Dimensions,” by Zhuang, et al., published as WO 2009/085218 on Jul. 9, 2009; or U.S. Pat. No. 7,838,302, issued Nov. 23, 2010, entitled “Sub-Diffraction Limit Image Resolution and Other Imaging Techniques,” by Zhuang, et al., each incorporated herein by reference.

In some cases, such as is shown in FIG. 1A, light from the laser is applied through an objective lens 25 to the sample, although in other embodiments, the laser light need not pass through an objective lens to reach the sample. Sample 15 may be any suitable sample, e.g., a biological sample, and the sample may contain an emissive entity, such as a photoswitchable emissive entity, that can be excited by the incident laser light to produce emissive light. As is shown in the example of FIG. 1A, emitted light from sample 15 travels through objective lens 25 towards polarizing beam splitter 40. In some cases, one or more optical components, including lenses, mirrors (e.g., dichroic mirrors or polychroic mirrors), beam splitters, filters, slits, windows, prisms, diffraction gratings, optical fibers, etc. may also be used to assist in directing the emitted light towards polarizing beam splitter 40. As a non-limiting example, as is shown in FIG. 1A, dichroic minor 30, tube lens 35, and relay lens 37 are used to assist in directing the emitted light.

The polarizing beam splitter alters the emitted light from the sample to produce polarized light. In some cases, more than one polarized beam can be produced, as is shown in FIG. 1A, and in some cases, two polarized beams are produced where the polarizations of each beam are substantially orthogonal to each other, shown in FIG. 1A as beams 41 and 42, which proceed via different imaging paths towards spatial light modulator 50. However, in some instances, only one polarized beam is needed. In addition, in some embodiments, one of beams is rotated by a half-wave plate 45 to align the polarizations of both beams prior to the beams reaching the spatial light modulator.

Beams 41 and 42 are directed via different imaging paths towards spatial light modulator 50. In some cases, there may also be one or more optical components used to direct the light towards the spatial light modulator, although there are none shown in the example of FIG. 1A. Spatial light modulator 50 may be used to alter the incoming polarized light to produce Airy beams. Airy beams can maintain their intensity profiles over large distances without substantial diffraction. The spatial light modulator may be, for example, electrically addressed, and in some cases it may comprise a liquid crystal display. In some embodiments, such as is shown in FIG. 1A, the spatial light modulator may display patterns, e.g., for each of beams 41 and 42. For instance, the spatial light modulator may display two patterns where each pattern is generally centered around each incident respective beam. The patterns may be substantially identical in some cases, although in other cases, the patterns are not substantially identical. In some embodiments, the spatial light modulator may exhibit different patterns for each of beams 41 and 42, or there may be more than one spatial light modulator present, e.g., such that each of beams 41 and 42 is controlled by a different spatial light modulator. In addition, in some cases, there may be only one polarization beam present, as previously noted.

In certain embodiments, spatial light modulator 50 may display a phase pattern useful in altering the incident polarized light to produce Airy beams or other non-diffracting beams of light, such as Bessel beams. For example, in one set of embodiments, spatial light modulator 50 may display a phase pattern based on a cubic phase pattern. More complex patterns may also be used in some cases, e.g., comprising a first region displaying a cubic phase pattern and a second region displaying a diffraction grating such as a linear diffraction grating. As discussed below, this may be useful, for example, to reduce higher-order side-lobes that may be created when producing Airy beams or other non-diffracting beams of light.

As discussed, emitted light from the entities can be divided into two polarized beams of light, where the polarization of the beams are substantially orthogonal to each other, prior to the beams being altered to produce Airy beams or other non-diffracting beams of light, such as Bessel beams, Mathieu beams, Weber beams, etc. Because Airy beams may exhibit lateral “bending” during propagation, and since the bending appears to occur in opposite directions during propagation for the two polarized beams (see, e.g., FIG. 1C), the amount of movement or deflection of an entity in each image based on the Airy beam, compared to its average position, may be used to determine the z position of the entity within the sample.

After production by the spatial light modulator, the Airy beams or other non-diffracting beams of light can be directed towards detector 60, e.g., via different imaging paths as is shown in FIG. 1A. In some cases, various optical components may be used to assist in directing the light towards the detector, for example, lenses, minors, beam splitters, filters, slits, windows, prisms, diffraction gratings, optical fibers, etc. As a non-limiting example, FIG. 1A includes a minor 55 and a relay lens 57, although other suitable optical components may also be used in other embodiments of the invention.

The detector may be any suitable detector for receiving the light. For example, the detector may include a CCD camera, a photodiode, a photodiode array, or the like. One or more than one detector may be used, e.g., for receiving each of the Airy beams resulting from beams 41 and 42. For example, in FIG. 1A, both beams are directed towards a single EMCCD camera.

The position of the entity in the z or axial direction may be determined, in some cases, at a resolution better than the wavelength of the light emitted by the entity, based on the acquired images. For example, if the images comprise Airy beams or other non-diffracting beams of light, the difference in x-y position of an entity in the two images, as acquired by a detector, may be a function of its z position, as previously mentioned. In some cases, entities farther away from the focal plane may exhibit greater differences between the two images, compared to entities closer to the focal plane; this difference may be quantified and used to determine z position of the entity away from the focal plane in some embodiments, as discussed herein. In addition, in some cases, this relationship may not necessarily be a linear relationship, e.g., due to the curved nature of the Airy beams.

In some embodiments, various super-resolution techniques may be used. For example, in some stochastic imaging techniques, incident light is applied to a sample to cause a statistical subset of entities present within the sample to emit light, the emitted light is acquired or imaged, and the entities are deactivated (e.g., spontaneously, or by causing the deactivation, for instance, with suitable deactivation light, etc.). This process may be repeated any number of times, each time causing a statistically different subset of the entities to emit light, and this process may be repeated to produce a final, stochastically produced image. In addition, in certain embodiments, the position of an emissive entity within the sample may be determined in 2 or 3 dimensions.

For instance, in one set of embodiments, two or more images of an emissive entity are acquired, e.g., via beams 41 and 42 as previously discussed, which can be analyzed using STORM or other stochastic imaging techniques to determine the positions of the emissive entities within the sample, e.g., in 2 or 3 dimensions. In some cases, super-resolution images can be obtained, e.g., where the position of the entity is known in 2 or 3 dimensions at a resolution better than the wavelength of the light emitted by the entity.

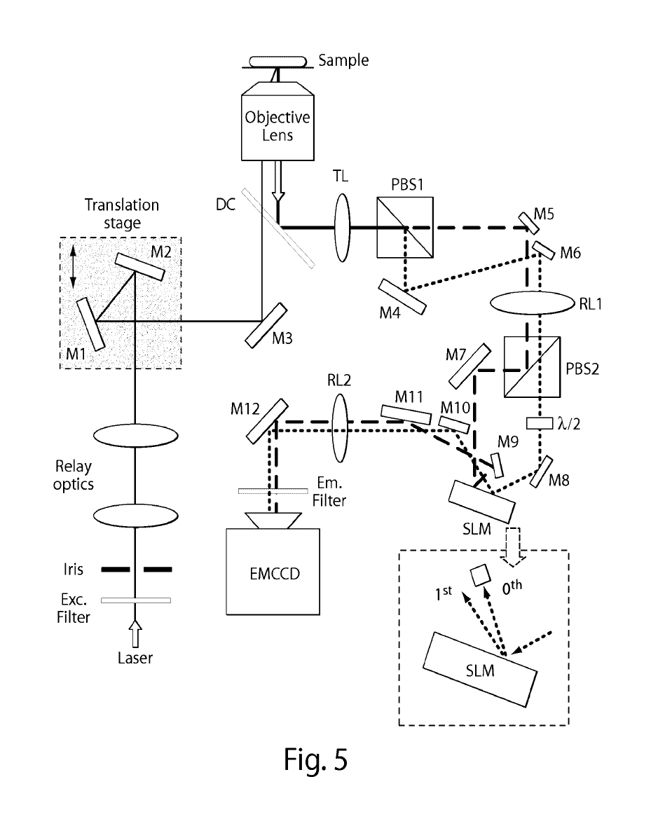

As mentioned, certain aspects of the present invention are directed to microscopy systems and components for microscopy systems, especially optical microscopy systems, able to produce super-resolution images (or data sets). The above discussion, with reference to FIG. 1A, is one example, but other systems are also possible in other embodiments; for example, another configuration is shown in FIG. 5. Various embodiments of the invention for use in determining the position of an emissive entity within the sample, in some cases at resolutions better than the wavelength of the light emitted by the entity, in 2 or 3 dimensions, are discussed herein. In addition, as mentioned, certain aspects of the present invention can be used with other microscopy systems, such as confocal microscopy systems or two-photon microscopy systems. For example, the emission path of a confocal microscopy or a two-photon microscopy system may be modified using components such as discussed herein, e.g., to produce Airy beams or other non-diffracting beams of light.

For instance, in certain embodiments, microscopy systems such as those discussed herein may be used for locating the z position of entities within a sample region (in addition to the x and y position). The z position is typically defined to be in a direction defined by an objective relative to the sample (e.g., towards or away from the objective, i.e., axially). In some cases, the z position is orthogonal to the focal (x-y) plane of the objective. The sample may be substantially positioned within the focal plane of the objective, and thus, the z direction may also be taken in some embodiments to be in a direction substantially normal to the sample or the sample region (or at least a plane defined by the sample, e.g., if the sample itself is not substantially flat), for instance, in embodiments where the sample and/or the sample region is substantially planar. However, it should be understood that the sample need not necessarily be within the focal plane in some cases. The position of an entity in a sample in the z direction may be determined in some embodiments at a resolution that is less than the diffraction limit of the incident light. For example, for visible light, the z position of an entity can be determined at a resolution less than about 1000 nm, less than about 800 nm, less than about 500 nm, less than about 300, less than about 200 nm, less than about 100 nm, less than about 50 nm, less than about 40 nm, less than about 35 nm, less than about 30 nm, less than about 25 nm, less than about 20 nm, less than about 15 nm, less than about 10 nm, or less than 5 nm, as discussed herein.

The sample region may be used to hold or contain a sample. The samples can be biological and/or non-biological in origin. For example, the sample studied may be a non-biological sample (or a portion thereof) such as a microchip, a MEMS device, a nanostructured material, or the sample may be a biological sample such as a cell, a tissue, a virus, or the like (or a portion thereof).

In some cases, the sample region is substantially planar, although in other cases, a sample region may have other shapes. In certain embodiments, the sample region (or the sample contained therein) has an average thickness of less than about 1 mm, less than about 300 micrometers, less than about 100 micrometers, less than about 30 micrometers, less than about 10 micrometers, less than about 3 micrometers, less than about 1 micrometer, less than about 750 nm, less than about 500 nm, less than about 300 nm, or less than about 150 nm. The sample region may be positioned in any orientation, for instance, substantially horizontally positioned, substantially vertically positioned, or positioned at any other suitable angle.

Any of a variety of techniques can be used to position a sample within the sample region. For example, the sample may be positioned in the sample region using clips, clamps, or other commonly-available mounting systems (or even just held there by gravity, in some cases). In some cases, the sample can be held or manipulated using various actuators or controllers, such as piezoelectric actuators. Suitable actuators having nanometer precision can be readily obtained commercially. For example, in certain embodiments, the sample may be positioned relative to a translation stage able to manipulate at least a portion of the sample region, and the translation stage may be controlled at nanometer precision, e.g., using piezoelectric control.

The sample region may be illuminated, in certain embodiments of the invention, using an illumination source that is able to illuminate at least a portion of the sample region. The illumination path need not be a straight line, but may also include suitable path leading from the illumination source, optionally through one or more optical components, to at least a portion of the sample region. For example, in FIG. 1A, a laser used as an illumination source passes through an objective lens and a dichroic mirror before reaching the sample.

The illumination source may be any suitable source able to illuminate at least a portion of the sample region. The illumination source can be, e.g., substantially monochromatic or polychromatic. The illumination source may also be, in some embodiments, steady-state or pulsed. In some cases, the illumination source produces coherent (laser) light. In one set of embodiments, at least a portion of the sample region is illuminated with substantially monochromatic light, e.g., produced by a laser or other monochromatic light source, and/or by using one or more filters to remove undesired wavelengths. In some cases, more than one illumination source may be used, and each of the illumination sources may be the same or different. For example, in some embodiments, a first illumination source may be used to activate entities in a sample region, and a second illumination source may be used to excite entities in the sample region, or to deactivate entities in the sample region, or to activate different entities in the sample region, etc.

In some cases, a controller may be used to control light produced by the illumination system. For example, the controller may be able to repeatedly or continuously expose the sample region to excitation light from the excitation light source and/or activation light from the activation light source, e.g., for use in STORM or other stochastic imaging techniques as discussed herein. The controller may apply the excitation light and the activation light to the sample in any suitable order. In some embodiments, the activation light and the excitation light may be applied at the same time (e.g., simultaneously). In some cases, the activation light and the excitation light may be applied sequentially. In various embodiments, the activation light may be continuously applied and/or the excitation light may be continuously applied. See also U.S. Pat. No. 7,838,302, issued Nov. 23, 2010, entitled “Sub-Diffraction Limit Image Resolution and Other Imaging Techniques,” by Zhuang, et al., incorporated herein by reference. The controller may be, for example, a computer. Various computers and other devices, including software, for performing STORM or other stochastic imaging techniques can be obtained commercially, e.g., from Nikon Corp.

In one set of embodiments, a computer and/or an automated system may be provided that is able to automatically and/or repetitively perform any of the methods described herein. As used herein, “automated” devices refer to devices that are able to operate without human direction, i.e., an automated device can perform a function during a period of time after any human has finished taking any action to promote the function, e.g. by entering instructions into a computer. Typically, automated equipment can perform repetitive functions after this point in time. The processing steps may also be recorded onto a machine-readable medium in some cases.

In some cases, a computer may be used to control activation and/or excitation of the sample and the acquisition of images of the sample, e.g., of switchable entities within the sample, including photoswitchable emissive entities such as those discussed herein. In one set of embodiments, a sample may be excited using light having various wavelengths and/or intensities, and the sequence of the wavelengths of light used to excite the sample may be correlated, using a computer, to the images acquired of the sample. For instance, the computer may apply light having various wavelengths and/or intensities to a sample to yield different average numbers of emitting entities in each region of interest (e.g., one entity per location, two entities per location, etc.). In some cases, this information may be used to construct an image of the entities, in some cases at sub-diffraction limit resolutions, as noted above.

Light emitted by the entities within the sample may then be collected, e.g., using an objective. The objective may be any suitable objective. For example, the objective may be an air or an immersion objective, for instance, oil immersion lenses, water immersion lenses, solid immersion lenses, etc. (although in other embodiments, other, non-immersion objectives can be used). The objective can have any suitable magnification and any suitable numerical aperture, although higher magnification objectives are typically preferred. For example, the objective may be about 4×, about 10×, about 20×, about 32×, about 50×, about 64×, about 100×, about 120×, etc., while in some cases, the objective may have a magnification of at least about 50×, at least about 80×, or at least about 100×, The numerical aperture can be, for instance, about 0.2, about 0.4, about 0.6, about 0.8, about 1.0, about 1.2, about 1.4, etc. In certain embodiments, the numerical aperture is at least 1.0, at least 1.2, or at least 1.4. Many types of microscope objectives are commercially available. Any number of objectives may be used in different embodiments of the invention, and the objectives may each independently be the same or different.

The light emitted by the entities may then be directed via any number of imaging paths, ultimately to a detector. As discussed herein, the emitted light may be polarized to produce one or more polarized beams, and/or altered to produce an Airy beam or other non-diffracting beams of light, prior to reaching the detector. In some cases, additional optical components may be used to control or direct the light throughout this process. The imaging path can be any path leading from the sample region, optionally through one or more optical components, to a detector such that the detector can be used to acquire an image of the sample region. The imaging path may not necessarily be a straight line, although it can be in certain instances.

Any of a variety of optical components may be present, and may serve various functions. Optical components may be present to guide the imaging path around the microscopy system, to reduce noise or unwanted wavelengths of light, or the like. For example, various optical components can be used to direct light from the sample to the polarizing beam splitter or other polarizer. Non-limiting examples of optical components that may be present within the imaging path (or elsewhere in the microscopy system, such as in an illumination path between a source of illumination and a sample region) include one or more optical components such as lenses, mirrors (for example, dichroic minors, polychroic minors, one-way mirrors, etc.), beam splitters, filters, slits, windows, prisms, diffraction gratings, optical fibers, and any number or combination of these may be present in various embodiments of the invention. One non-limiting example of a microscopy system containing several optical components in various imaging paths between a sample region through various objectives to a common detector is shown in FIG. 1A.

In one set of embodiments, the emitted light may be polarized to form a polarized beam, and in some cases, the emitted light may be split to form two polarized beams. In some cases, the polarization of the polarized beams may be substantially orthogonal to each other. The polarization may be linear or circular. The emitted light may be polarized using, for instance, an absorptive polarizer or a polarizing beam splitter. Non-limiting examples of polarizing beam splitters include a Wollaston prism, a Nomarski prism, a Nicol prism, a Glan-Thompson prism, a Glan-Foucault prism, a Senarmont prism, or a Rochon prism. Various polarizing beam splitters or other polarizers are readily available commercially. In some cases, both polarized beams may be directed via various imaging paths and/or various optical components to subsequent operations, e.g., as discussed below.

As mentioned, in certain cases, one or more of the polarized beams may be altered to produce a self-bending point spread function or a non-diffracting beam of light, such as an Airy beam, a Bessel beam, a Mathieu beam, a Weber beam, or the like. In general, beams of light that have waveforms satisfying the wave-propagation equation will be non-diffracting. Although the term “non-diffracting beam” is commonly used by those of ordinary skill in the art, it is understood that even in such beams, some amount of diffraction may occur in reality, although substantially smaller than ordinary light beams, for example, Gaussian beams. In some cases, the non-diffracting beam achieved in reality is an approximation of a mathematically exact non-diffracting beam; however, the term “non-diffracting beam” is typically used to cover all of these scenarios by those of ordinary skill in the art.

Non-diffracting beams such as Airy beams and Bessel beams can propagate over significant distances without appreciable change in their intensity profiles, and may be self-healing under certain conditions, even after being obscured in scattering media. For example, a self-healing beam may be partially obstructed at one point, but the beam may substantially re-form further down the beam axis.

Airy beams and Bessel beams are named after the integral functions (Airy and Bessel functions, respectively) used to produce the beams. It should also be noted that Airy functions, as used herein, include both Airy functions of the first kind (Ai) and Airy functions of the second kind (Bi); similarly, Bessel functions as used herein include Bessel functions of the first kind (J) and Bessel functions of the second kind (Y), as well as linear combinations of these, in some cases. In one set of embodiments, such alterations may be useful to propagate such beams of light over longer distances (e.g., within the microscopy system) without substantial diffraction or spreading, and/or to prevent or reduce the amount of scattering caused by propagation of the beams through air or other media.

An Airy beam may give the appearance of a curved beam. See, e.g., FIGS. 1C and 1D. Airy beams and related waveforms (e.g., various self-bending point spread functions) may undergo lateral displacement as they propagate along the optical axis, resulting in light paths that appear to bend. The beam generally results from the interference of light emerging from a source of the beam, thus producing such effects as non-diffraction and “bending,” which may appear somewhat counterintuitive. Such beams are generally asymmetric, with one bright region at the center and a series of progressively dimmer patches on one side of the central spot. But rather than propagating in a straight line, the entire pattern of bright and dark patches appears to curve toward one side, thus giving the Airy beam (or other self-bending point spread function) a curved appearance.

In one set of embodiments, an Airy beam (or other non-diffracting beam, such as a Bessel beam) is produced by directing light at a spatial light modulator. The spatial light modulator may be, for example, an electrically addressed spatial light modulator or an optically addressed spatial light modulator. Many such spatial light modulators are available commercially, e.g., based on liquid crystal displays such as ferroelectric liquid crystals or nematic liquid crystals. In some cases, a spatial light modulator can alter the phasing of the incident light to produce an Airy beam (or other non-diffracting beam, such as a Bessel beam). For example, the spatial light modulator may be configured to display a cubic phase pattern that is able to convert the incident light into an Airy beam. In addition, it should be understood that other methods may be used to produce Airy beams or other non-diffracting beams in other embodiments of the invention. For example, such beams may be produced using an axicon lens (e.g., lenses having conical surfaces), linear diffractive elements, modulated crystal structures or domains (e.g., quasi-phase matched structures made from nonlinear crystals, for example, lithium tantalite), cubic phase masks fabricated by photolithography, or the like.

In some embodiments, only a portion of the spatial light modulator may be configured to display a cubic phase pattern, although other patterns are also possible in other embodiments. Other portions may be configured as diffraction gratings, such as linear diffraction gratings, random phasings, or the like, which may be used, for example, to discard portions of the incident light. For instance, without wishing to be bound by any theory, it is believed that conventional Airy beams using a cubic phase pattern may lead to large “side-lobes” or other regions that may prevent imaging of densely labeled samples, and/or hinder accurate localization of entities within the sample. Accordingly, in certain embodiments, portions of the incident light are discarded or not otherwise directed at the detector, e.g., by using diffraction gratings, random phasings, etc.

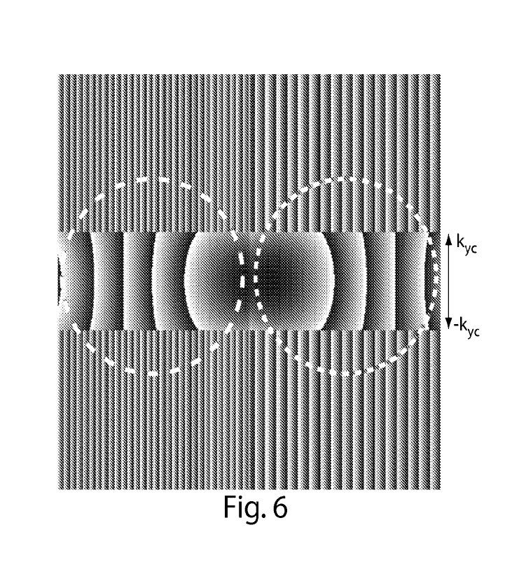

In some embodiments, more than one spatial light modulator is used, e.g., one for each of the polarized beams. However, in certain embodiments, only one spatial light modulator is used, even if more than one polarized beam is used. For example, each polarized beam may be directed at the spatial light modulator, and the spatial light modulator may display patterns for each of the polarized beams. In some cases, each of the patterns may be substantially centered around each of the incident polarized beams. See, e.g., FIG. 6. However, it should be understood that the two patterns need not be substantially identical, although they can be in some cases.

In addition, in some cases, a light beam may be modified to produce a light beam such that the lateral position or shape of the beam is a function of the propagation distance. For example, in some embodiments, light beams may be used where the z position of an entity is encoded in the lateral (x-y) position of images of the entity, or where the position of the emission light beam depends on the propagation distance. One example of such a beam is an Airy beam, as discussed herein. However, other light beams may also be used as well, and such light beams may be diffracting or non-diffracting. For example, the beam may be a Gauss-Laguerre beam, where the rotational angle of the beam is a function of the propagation distance.

After production of the Airy beams or other non-diffracting beams, these beams may then be directed at a detector. In some cases, one or more optical components may be used to direct the beams, including any of the optical components discussed herein. The detector can be any device able to acquire one or more images of the sample region, e.g., via an imaging path. For example, the detector may be a camera such as a CCD camera (such as an EMCCD camera), a photodiode, a photodiode array, a photomultiplier, a photomultiplier array, a spectrometer, or the like. The detector may be able to acquire monochromatic and/or polychromatic images, depending on the application. Those of ordinary skill in the art will be aware of detectors suitable for microscopy systems, and many such detectors are commercially available.

In one set of embodiments, a single detector is used, and multiple imaging paths may be routed to the common detector using various optical components such as those described herein. For example, more than one Airy beam or polarization beam may be directed at a single, common detector. A common detector may be advantageous, for example, since no calibration or correction may need to be performed between multiple detectors. For instance, with a common detector, there may be no need to correct for differences in intensity, brightness, contrast, gain, saturation, color, etc. between different detectors. In some embodiments, images from multiple imaging paths may be acquired by the detector simultaneously, e.g., as portions of the same overall frame acquired by the detector. This could be useful, for instance, to ensure that the images are properly synchronized with respect to time.

However, in other embodiments of the invention, more than one detector may be used, and the detectors may each independently be the same or different. In some cases, multiple detectors may be used, for example, to improve resolution and/or to reduce noise. For example, at least 2, at least 5, at least 10, at least 20, at least 25, at least 50, at least 75, at least 100, etc. detectors may be used, depending on the application. This may be useful, for example, to simplify the collection of images via different imaging paths.

In some cases, more than two detectors may be present within the microscopy system.

Images acquired by the detector may be immediately processed, or stored for later use. For example, certain embodiments of the invention are generally directed to techniques for resolving two or more entities, even at distances of separation that are less than the wavelength of the light emitted by the entities or below the diffraction limit of the emitted light. The resolution of the entities may be, for instance, on the order of 1 micrometer (1000 nm) or less, as described herein. For example, if the emitted light is visible light, the resolution may be less than about 700 nm. In some cases, two (or more) entities may be resolved even if separated by a distance of less than about 500 nm, less than about 300 nm, less than about 200 nm, less than about 100 nm, less than about 80 nm, less than about 60 nm, less than about 50 nm, or less than about 40 nm. In some cases, two or more entities separated by a distance of less than about 20 nm, less than 10 nm, or less than 5 nm can be resolved using various embodiments of the present invention. The positions of the entities may be determined in 2 dimensions (e.g., in the x-y plane), or in 3 dimensions in some cases, as discussed herein.

In some cases, a final image (or data set, e.g., encoding an image) may be assembled or constructed from the positions of the entities, or a subset of entities in the sample, in some embodiments of the invention. In some cases, the data set may include position information of the entities in the x, y, and optionally z directions. As an example, the final coordinates of an entity may be determined as the average of the position of the entity as determined using different Airy beams or polarized beams, as discussed above. The entities may also be colored in a final image in some embodiments, for example, to represent the degree of uncertainty, to represent the location of the entity in the z direction, to represent changes in time, etc. In one set of embodiments, a final image or data set may be assembled or constructed based on only the locations of accepted entities while suppressing or eliminating the locations of rejected entities.

In one set of embodiments, the z position of an emissive entity may be determined using images of two Airy beams that are produced from different polarized beams of the emissive entity, e.g., where the polarized beams are substantially orthogonally polarized. Without wishing to be bound by any theory, it is believed that because Airy beams exhibit lateral “bending” during propagation, and since the bending appears to occur in opposite directions during propagation for each of the two polarized beams (see, e.g., FIG. 1C), the amount of movement or deflection of an entity in each Airy beam, compared to its average position, may be used to determine the z position of the entity within the sample, while the actual position of the entity within the image (i.e., the x and y positions of the entity) may be determined using the average of the positions within the two images. Thus, for example, an entity within the focal plane may appear to be in substantially the same position in the two images, while an entity further away from the focal plane may exhibit differences in position within the two images, with the difference in position being a function of the distance the entity is away from the focal plane, due to the opposed bending of the Airy beams. These differences can be quantified in some embodiments, thereby yielding the z position of the entity within the sample. In addition, in some cases, the difference may be non-linear, i.e., the deflection in position of an entity (reflecting its z position), as compared to its average position (reflecting its x-y position), may not be a strictly linear function of the distance between the entity and the focal plane of the image. For example, the function may appear to bend, as shown in FIG. 1E.

Various image-processing techniques may also be used to facilitate determination of the entities, e.g., within the images. As an example, drift correction or noise filters may be used. Generally, in drift correction, for example, a fixed point is identified (for instance, as a fiduciary marker, e.g., a fluorescent particle may be immobilized to a substrate), and movements of the fixed point (i.e., due to mechanical drift) are used to correct the determined positions of the switchable entities. In another example method for drift correction, the correlation function between images acquired in different imaging frames or activation frames can be calculated and used for drift correction. In some embodiments, the drift may be less than about 1000 nm/min, less than about 500 nm/min, less than about 300 nm/min, less than about 100 nm/min, less than about 50 nm/min, less than about 30 nm/min, less than about 20 nm/min, less than about 10 nm/min, or less than 5 nm/min. Such drift may be achieved, for example, in a microscope having a translation stage mounted for x-y positioning of the sample slide with respect to the microscope objective. The slide may be immobilized with respect to the translation stage using a suitable restraining mechanism, for example, spring loaded clips.

In certain aspects of the invention, images of a sample may be obtained using stochastic imaging techniques. In many stochastic imaging techniques, various entities are activated and emit light at different times and imaged; typically the entities are activated in a random or “stochastic” manner. For example, a statistical or “stochastic” subset of the entities within a sample can be activated from a state not capable of emitting light at a specific wavelength to a state capable of emitting light at that wavelength. Some or all of the activated entities may be imaged (e.g., upon excitation of the activated entities), and this process repeated, each time activating another statistical or “stochastic” subset of the entities. Optionally, the entities are deactivated (for example, spontaneously, or by causing the deactivation, for instance, with suitable deactivation light). Repeating this process any suitable number of times allows an image of the sample to be built up using the statistical or “stochastic” subset of the activated emissive entities activated each time. Higher resolutions may be achieved in some cases because the emissive entities are not all simultaneously activated, making it easier to resolve closely positioned emissive entities. Non-limiting examples of stochastic imaging techniques which may be used include stochastic optical reconstruction microscopy (STORM), single-molecule localization microscopy (SMLM), spectral precision distance microscopy (SPDM), super-resolution optical fluctuation imaging (SOFT), photoactivated localization microscopy (PALM), and fluorescence photoactivation localization microscopy (FPALM). In addition, in some cases, techniques such as those discussed herein can be combined with other 3-dimensional techniques for determining the position of entities within a sample; see, e.g.,

International Patent Application No. PCT/U52008/013915, filed Dec. 19, 2008, entitled “Sub-diffraction Limit Image Resolution in Three Dimensions,” by Zhuang, et al., incorporated herein by reference in its entirety.

In certain embodiments, the resolution of the entities in the images can be, for instance, on the order of 1 micrometer or less, as described herein. In some cases, the resolution of an entity may be determined to be less than the wavelength of the light emitted by the entity, and in some cases, less than half the wavelength of the light emitted by the entity. For example, if the emitted light is visible light, the resolution may be determined to be less than about 700 nm. In some cases, two (or more) entities can be resolved even if separated by a distance of less than about 500 nm, less than about 300 nm, less than about 200 nm, less than about 100 nm, less than about 80 nm, less than about 60 nm, less than about 50 nm, or less than about 40 nm. In some cases, two or more entities separated by a distance of less than about 35 nm, less than about 30 nm, less than about 25 nm, less than about 20 nm, less than about 15 nm, less than about 10 nm, or less than about 5 nm can be resolved using embodiments of the present invention.

One non-limiting example is stochastic optical reconstruction microscopy (STORM). See, e.g., U.S. Pat. No. 7,838,302, issued Nov. 23, 2010, entitled “Sub-Diffraction Limit Image Resolution and Other Imaging Techniques,” by Zhuang, et al., incorporated herein by reference in its entirety. In STORM, incident light is applied to emissive entities within a sample in a sample region to activate the entities, where the incident light has an intensity and/or frequency that is able to cause a statistical subset of the plurality of emissive entities to become activated from a state not capable of emitting light (e.g., at a specific wavelength) to a state capable of emitting light (e.g., at that wavelength). Once activated, the emissive entities may spontaneously emit light, and/or excitation light may be applied to the activated emissive entities to cause these entities to emit light. The excitation light may be of the same or different wavelength as the activation light. The emitted light can be collected or acquired, e.g., in one, two, or more objectives as previously discussed. In certain embodiments the positions of the entities can be determined in two or three dimensions from their images. In some cases, the excitation light is also able to subsequently deactivate the statistical subset of the plurality of emissive entities, and/or the entities may be deactivated via other suitable techniques (e.g., by applying deactivation light, by applying heat, by waiting a suitable period of time, etc.). This process repeated as needed, each time with a statistically different subset of the plurality of emissive entities to emit light. In this way, a stochastic image of some or all of the emissive entities within a sample may be produced, e.g., from the determined positions of the entities. In addition, as discussed herein, various image processing techniques, such as noise reduction and/or x, y and/or z position determination can be performed on the acquired images.

In some cases, incident light having a sufficiently weak intensity may be applied to a plurality of entities such that only a subset or fraction of the entities within the incident light are activated, e.g., on a stochastic or random basis. The amount of activation can be any suitable fraction, e.g., less than about 0.01%, less than about 0.03%, less than about 0.05%, less than about 0.1%, less than about 0.3%, less than about 0.5%, less than about 1%, less than about 3%, less than about 5%, less than about 10%, less than less than about 15%, less than about 20%, less than about 25%, less than about 30%, less than about 35%, less than about 40%, less than about 45%, less than about 50%, less than about 55%, less than about 60%, less than about 65%, less than about 70%, less than about 75%, less than about 80%, less than about 85%, less than about 90%, or less than about 95% of the entities may be activated, depending on the application. For example, by appropriately choosing the intensity of the incident light, a sparse subset of the entities may be activated such that at least some of them are optically resolvable from each other and their positions can be determined. In some embodiments, the activation of the subset of the entities can be synchronized by applying a short duration of incident light. Iterative activation cycles may allow the positions of all of the entities, or a substantial fraction of the entities, to be determined. In some cases, an image with sub-diffraction limit resolution can be constructed using this information.

Multiple locations on a sample can each be analyzed to determine the entities within those locations. For example, a sample may contain a plurality of various entities, some of which are at distances of separation that are less than the wavelength of the light emitted by the entities or below the diffraction limit of the emitted light. Different locations within the sample may be determined (e.g., as different pixels within an image), and each of those locations independently analyzed to determine the entity or entities present within those locations. In some cases, the entities within each location are determined to resolutions that are less than the wavelength of the light emitted by the entities or below the diffraction limit of the emitted light, as previously discussed.

The emissive entities may be any entity able to emit light. For instance, the entity may be a single molecule. Non-limiting examples of emissive entities include fluorescent entities (fluorophores) or phosphorescent entities, for example, fluorescent dyes such as cyanine dyes (e.g., Cy2, Cy3, Cy5, Cy5.5, Cy7, etc.), Alexa dyes (e.g. Alexa Fluor 647, Alexa Fluor 750, Alexa Fluor 568, Alexa Fluor 488, etc.), Atto dyes (e.g.. Atto 488, Atto 565, etc.), metal nanoparticles, semiconductor nanoparticles or “quantum dots,” or fluorescent proteins such as GFP (Green Fluorescent Protein). Other light-emissive entities are known to those of ordinary skill in the art. As used herein, the term “light” generally refers to electromagnetic radiation, having any suitable wavelength (or equivalently, frequency). For instance, in some embodiments, the light may include wavelengths in the optical or visual range (for example, having a wavelength of between about 380 nm and about 750 nm, i.e., “visible light”), infrared wavelengths (for example, having a wavelength of between about 700 micrometers and 1000 nm), ultraviolet wavelengths (for example, having a wavelength of between about 400 nm and about 10 nm), or the like. In certain cases, as discussed in detail below, more than one type of entity may be used, e.g., entities that are chemically different or distinct, for example, structurally. However, in other cases, the entities are chemically identical or at least substantially chemically identical. In one set of embodiments, an emissive entity in a sample is an entity such as an activatable entity, a switchable entity, a photoactivatable entity, or a photoswitchable entity. Examples of such entities are discussed herein. In some cases, more than one type of emissive entity may be present in a sample. An entity is “activatable” if it can be activated from a state not capable of emitting light (e.g., at a specific wavelength) to a state capable of emitting light (e.g., at that wavelength). The entity may or may not be able to be deactivated, e.g., by using deactivation light or other techniques for deactivating light. An entity is “switchable” if it can be switched between two or more different states, one of which is capable of emitting light (e.g., at a specific wavelength). In the other state(s), the entity may emit no light, or emit light at a different wavelength. For instance, an entity can be “activated” to a first state able to produce light having a desired wavelength, and “deactivated” to a second state not able to produce light of the same wavelength.

If the entity is activatable using light, then the entity is a “photoactivatable” entity. Similarly, if the entity is switchable using light in combination or not in combination with other techniques, then the entity is a “photoswitchable” entity. For instance, a photoswitchable entity may be switched between different light-emitting or non-emitting states by incident light of different wavelengths. Typically, a “switchable” entity can be identified by one of ordinary skill in the art by determining conditions under which an entity in a first state can emit light when exposed to an excitation wavelength, switching the entity from the first state to the second state, e.g., upon exposure to light of a switching wavelength, then showing that the entity, while in the second state, can no longer emit light (or emits light at a reduced intensity) or emits light at a different wavelength when exposed to the excitation wavelength.

Non-limiting examples of switchable entities (including photoswitchable entities) are discussed in U.S. Pat. No. 7,838,302, issued Nov. 23, 2010, entitled “Sub-Diffraction Limit Image Resolution and Other Imaging Techniques,” by Zhuang, et al., incorporated herein by reference. As a non-limiting example of a switchable entity, Cy5 can be switched between a fluorescent and a dark state in a controlled and reversible manner by light of different wavelengths, e.g., 633 nm, 647 nm or 657 nm red light can switch or deactivate Cy5 to a stable dark state, while 405 nm or 532 nm green light can switch or activate the Cy5 back to the fluorescent state. Other non-limiting examples of switchable entities include fluorescent proteins or inorganic particles, e.g., as discussed herein. In some cases, the entity can be reversibly switched between the two or more states, e.g., upon exposure to the proper stimuli. For example, a first stimulus (e.g., a first wavelength of light) may be used to activate the switchable entity, while a second stimulus (e.g., a second wavelength of light or light with the first wavelength) may be used to deactivate the switchable entity, for instance, to a non-emitting state. Any suitable method may be used to activate the entity. For example, in one embodiment, incident light of a suitable wavelength may be used to activate the entity to be able to emit light, and the entity can then emit light when excited by an excitation light. Thus, the photoswitchable entity can be switched between different light-emitting or non-emitting states by incident light.

In some embodiments, the switchable entity includes a first, light-emitting portion (e.g,. a fluorophore), and a second portion that activates or “switches” the first portion. For example, upon exposure to light, the second portion of the switchable entity may activate the first portion, causing the first portion to emit light. Examples of activator portions include, but are not limited to, Alexa Fluor 405 (Invitrogen), Alexa 488 (Invitrogen), Cy2 (GE Healthcare), Cy3 (GE Healthcare), Cy3.5 (GE Healthcare), or Cy5 (GE Healthcare), or other suitable dyes. Examples of light-emitting portions include, but are not limited to, Cy5, Cy5.5 (GE Healthcare), or Cy7 (GE Healthcare), Alexa Fluor 647 (Invitrogen), or other suitable dyes. These may be linked together, e.g., covalently, for example, directly, or through a linker, e.g., forming compounds such as, but not limited to, Cy5-Alexa Fluor 405, Cy5-Alexa Fluor 488, Cy5-Cy2, Cy5-Cy3, Cy5-Cy3.5, Cy5.5-Alexa Fluor 405, Cy5.5-Alexa Fluor 488, Cy5.5-Cy2, Cy5.5-Cy3, Cy5.5-Cy3.5, Cy7-Alexa Fluor 405, Cy7-Alexa Fluor 488, Cy7-Cy2, Cy7-Cy3, Cy7-Cy3.5, or Cy7-Cy5. The structures of Cy3, Cy5, Cy5.5, and Cy7 are shown in FIG. 6 with a non-limiting example of a linked version of Cy3-Cy5 shown in FIG. 6E; those of ordinary skill in the art will be aware of the structures of these and other compounds, many of which are available commercially.

In certain cases, the light-emitting portion and the activator portions, when isolated from each other, may each be fluorophores, i.e., entities that can emit light of a certain, emission wavelength when exposed to a stimulus, for example, an excitation wavelength. However, when a switchable entity is formed that comprises the first fluorophore and the second fluorophore, the first fluorophore forms a first, light-emitting portion and the second fluorophore forms an activator portion that switches that activates or “switches” the first portion in response to a stimulus. For example, the switichable entity may comprise a first fluorophore directly bonded to the second fluorophore, or the first and second entity may be connected via a linker or a common entity. Whether a pair of light-emitting portion and activator portion produces a suitable switchable entity can be tested by methods known to those of ordinary skills in the art. For example, light of various wavelength can be used to stimulate the pair and emission light from the light-emitting portion can be measured to determined wither the pair makes a suitable switch.

In some cases, the activation light and deactivation light have the same wavelength. In some cases, the activation light and deactivation light have different wavelengths. In some cases, the activation light and excitation light have the same wavelength. In some cases, the activation light and excitation light have different wavelengths. In some cases, the excitation light and deactivation light have the same wavelength. In some cases, the excitation light and deactivation light have different wavelengths. In some cases, the activation light, excitation light and deactivation light all have the same wavelength. The light may be monochromatic (e.g., produced using a laser) or polychromatic.

In another embodiment, the entity may be activated upon stimulation by electric fields and/or magnetic fields. In other embodiments, the entity may be activated upon exposure to a suitable chemical environment, e.g., by adjusting the pH, or inducing a reversible chemical reaction involving the entity, etc. Similarly, any suitable method may be used to deactivate the entity, and the methods of activating and deactivating the entity need not be the same. For instance, the entity may be deactivated upon exposure to incident light of a suitable wavelength, or the entity may be deactivated by waiting a sufficient time.

In one set of embodiments, the switchable entity can be immobilized, e.g., covalently, with respect to a binding partner, i.e., a molecule that can undergo binding with a particular analyte. Binding partners include specific, semi-specific, and non-specific binding partners as known to those of ordinary skill in the art. The term “specifically binds,” when referring to a binding partner (e.g., protein, nucleic acid, antibody, etc.), refers to a reaction that is determinative of the presence and/or identity of one or other member of the binding pair in a mixture of heterogeneous molecules (e.g., proteins and other biologics). Thus, for example, in the case of a receptor/ligand binding pair, the ligand would specifically and/or preferentially select its receptor from a complex mixture of molecules, or vice versa. Other examples include, but are not limited to, an enzyme would specifically bind to its substrate, a nucleic acid would specifically bind to its complement, an antibody would specifically bind to its antigen. The binding may be by one or more of a variety of mechanisms including, but not limited to ionic interactions, and/or covalent interactions, and/or hydrophobic interactions, and/or van der Waals interactions, etc. By immobilizing a switchable entity with respect to the binding partner of a target molecule or structure (e.g., DNA or a protein within a cell), the switchable entity can be used for various determination or imaging purposes. For example, a switchable entity having an amine-reactive group may be reacted with a binding partner comprising amines, for example, antibodies, proteins or enzymes.

In some embodiments, more than one switchable entity may be used, and the entities may be the same or different. In some cases, the light emitted by a first entity and the light emitted by a second entity have the same wavelength. The entities may be activated at different times and the light from each entity may be determined separately.

This allows the location of the two entities to be determined separately and, in some cases, the two entities may be spatially resolved, even at distances of separation that are less than the wavelength of the light emitted by the entities or below the diffraction limit of the emitted light (i.e., “sub-diffraction limit” resolutions). In certain instances, the light emitted by a first entity and the light emitted by a second entity have different wavelengths (for example, if the first entity and the second entity are chemically different, and/or are located in different environments). The entities may be spatially resolved even at distances of separation that are less than the wavelength of the light emitted by the entities or below the diffraction limit of the emitted light. In certain instances, the light emitted by a first entity and the light emitted by a second entity have substantially the same wavelengths, but the two entities may be activated by light of different wavelengths and the light from each entity may be determined separately. The entities may be spatially resolved even at distances of separation that are less than the wavelength of the light emitted by the entities, or below the diffraction limit of the emitted light.

In some cases, the entities may be independently switchable, i.e., the first entity may be activated to emit light without activating a second entity. For example, if the entities are different, the methods of activating each of the first and second entities may be different (e.g., the entities may each be activated using incident light of different wavelengths). As another non-limiting example, if the entities are substantially the same, a sufficiently weak intensity of light may be applied to the entities such that only a subset or fraction of the entities within the incident light are activated, i.e., on a stochastic or random basis. Specific intensities for activation can be determined by those of ordinary skill in the art using no more than routine skill. By appropriately choosing the intensity of the incident light, the first entity may be activated without activating the second entity. The entities may be spatially resolved even at distances of separation that are less than the wavelength of the light emitted by the entities, or below the diffraction limit of the emitted light. As another non-limiting example, the sample to be imaged may comprise a plurality of entities, some of which are substantially identical and some of which are substantially different. In this case, one or more of the above methods may be applied to independently switch the entities. The entities may be spatially resolved even at distances of separation that are less than the wavelength of the light emitted by the entities, or below the diffraction limit of the emitted light.

In some cases, incident light having a sufficiently weak intensity may be applied to a plurality of entities such that only a subset or fraction of the entities within the incident light are activated, e.g., on a stochastic or random basis. The amount of activation may be any suitable fraction, e.g., about 0.1%, about 0.3%, about 0.5%, about 1%, about 3%, about 5%, about 10%, about 15%, about 20%, about 25%, about 30%, about 35%, about 40%, about 45%, about 50%, about 55%, about 60%, about 65%, about 70%, about 75%, about 80%, about 85%, about 90%, or about 95% of the entities may be activated, depending on the application. For example, by appropriately choosing the intensity of the incident light, a sparse subset of the entities may be activated such that at least some of them are optically resolvable from each other and their positions can be determined. In some embodiments, the activation of the subset of the entities can be synchronized by applying a short duration of the incident light. Iterative activation cycles may allow the positions of all of the entities, or a substantial fraction of the entities, to be determined. In some cases, an image with sub-diffraction limit resolution can be constructed using this information.

In some embodiments, a microscope may be configured so to collect light emitted by the switchable entities while minimizing light from other sources of fluorescence (e.g., “background noise”). In certain cases, imaging geometry such as, but not limited to, a total-internal-reflection geometry, a spinning-disc confocal geometry, a scanning confocal geometry, an epi-fluorescence geometry, an epi-fluorescence geometry with an oblique incidence angle, etc., may be used for sample excitation. In some embodiments, as previously discussed, a thin layer or plane of the sample is exposed to excitation light, which may reduce excitation of fluorescence outside of the sample plane. A high numerical aperture lens may be used to gather the light emitted by the sample. The light may be processed, for example, using filters to remove excitation light, resulting in the collection of emission light from the sample. In some cases, the magnification factor at which the image is collected can be optimized, for example, when the edge length of each pixel of the image corresponds to the length of a standard deviation of a diffraction limited spot in the image.

In some embodiments of the invention, the switchable entities may also be resolved as a function of time. For example, two or more entities may be observed at various time points to determine a time-varying process, for example, a chemical reaction, cell behavior, binding of a protein or enzyme, etc. Thus, in one embodiment, the positions of two or more entities may be determined at a first point of time (e.g., as described herein), and at any number of subsequent points of time. As a specific example, if two or more entities are immobilized relative to a common entity, the common entity may then be determined as a function of time, for example, time-varying processes such as movement of the common entity, structural and/or configurational changes of the common entity, reactions involving the common entity, or the like. The time-resolved imaging may be facilitated in some cases since a switchable entity can be switched for multiple cycles, with each cycle giving one data point of the position of the entity.

In some cases, one or more light sources may be time-modulated (e.g., by shutters, acoustic optical modulators, or the like). Thus, a light source may be one that is activatable and deactivatable in a programmed or a periodic fashion. In one embodiment, more than one light source may be used, e.g., which may be used to illuminate a sample with different wavelengths or colors. For instance, the light sources may emanate light at different frequencies, and/or color-filtering devices, such as optical filters or the like, may be used to modify light coming from the light sources such that different wavelengths or colors illuminate a sample.

Various image-processing techniques may also be used to facilitate determination of the entities. For example, drift correction or noise filters may be used. Generally, in drift correction, a fixed point is identified (for instance, as a fiduciary marker, e.g., a fluorescent particle may be immobilized to a substrate), and movements of the fixed point (i.e., due to mechanical drift) are used to correct the determined positions of the switchable entities. In another example method for drift correction, the correlation function between images acquired in different imaging frames or activation frames can be calculated and used for drift correction. In some embodiments, the drift may be less than about 1000 nm/min, less than about 500 nm/min, less than about 300 nm/min, less than about 100 nm/min, less than about 50 nm/min, less than about 30 nm/min, less than about 20 nm/min, less than about 10 nm/min, or less than 5 nm/min. Such drift may be achieved, for example, in a microscope having a translation stage mounted for x-y positioning of the sample slide with respect to the microscope objective. The slide may be immobilized with respect to the translation stage using a suitable restraining mechanism, for example, spring loaded clips. In addition, a buffer layer may be mounted between the stage and the microscope slide. The buffer layer may further restrain drift of the slide with respect to the translation stage, for example, by preventing slippage of the slide in some fashion. The buffer layer, in one embodiment, is a rubber or polymeric film, for instance, a silicone rubber film.

Accordingly, one embodiment of the invention is directed to a device comprising a translation stage, a restraining mechanism (e.g., a spring loaded clip) attached to the translation stage able to immobilize a slide, and optionally, a buffer layer (e.g., a silicone rubber film) positioned such that a slide restrained by the restraining mechanism contacts the buffer layer. To stabilize the microscope focus during data acquisition, a “focus lock” device may be used in some cases. As a non-limiting example, to achieve focus lock, a laser beam may be reflected from the substrate holding the sample and the reflected light may be directed onto a position-sensitive detector, for example, a quadrant photodiode. In some cases, the position of the reflected laser, which may be sensitive to the distance between the substrate and the objective, may be fed back to a z-positioning stage, for example a piezoelectric stage, to correct for focus drift. The device may also include, for example, a spatial light modulator and/or a polarizer, e.g., as discussed herein.

Another aspect of the invention is directed to a computer-implemented method. For instance, a computer and/or an automated system may be provided that is able to automatically and/or repetitively perform any of the methods described herein. In some cases, a computer may be used to control excitation of the switchable entities and the acquisition of images of the switchable entities. In one set of embodiments, a sample may be excited using light having various wavelengths and/or intensities, and the sequence of the wavelengths of light used to excite the sample may be correlated, using a computer, to the images acquired of the sample containing the switchable entities. For instance, the computer may apply light having various wavelengths and/or intensities to a sample to yield different average numbers of activated switchable elements in each region of interest (e.g., one activated entity per location, two activated entities per location, etc.). In some cases, this information may be used to construct an image of the switchable entities, in some cases at sub-diffraction limit resolutions, as noted above.

Still other embodiments of the invention are generally directed to a system able to perform one or more of the embodiments described herein. For example, the system may include a microscope, a device for activating and/or switching the entities to produce light having a desired wavelength (e.g., a laser or other light source), a device for determining the light emitted by the entities (e.g., a camera, which may include color-filtering devices, such as optical filters), and a computer for determining the spatial positions of the two or more entities.

In other aspects of the invention, the systems and methods described herein may also be combined with other imaging techniques known to those of ordinary skill in the art, such as high-resolution fluorescence in situ hybridization (FISH) or immunofluorescence imaging, live cell imaging, confocal imaging, epi-fluorescence imaging, total internal reflection fluorescence imaging, etc. In one set of embodiments, an existing microscope (e.g., a commercially-available microscope) may be modified using components such as discussed herein, e.g., to acquire images and/or to determine the positions of emissive entities, as discussed herein.

U.S. Pat. No. 7,838,302, issued Nov. 23, 2010, entitled “Sub-Diffraction Limit Image Resolution and Other Imaging Techniques,” by Zhuang, et al.; International Patent Application No. PCT/U52008/013915, filed Dec. 19, 2008, entitled “Sub-Diffraction Limit Image Resolution in Three Dimensions,” by Zhuang, et al., published as WO 2009/085218 on Jul. 9, 2009; or International Patent Application No. PCT/U52012/069138, filed Dec. 15, 2012, entitled “High Resolution Dual-Objective Microscopy,” by Zhuang, et al., published as WO 2013/090360 on Jun. 20, 2013, are each incorporated herein by reference in its entirety.

Also incorporated herein by reference are U.S. Provisional Patent Application Ser. No. 61/934,928, filed Feb. 3, 2014, entitled “Three-Dimensional Super-Resolution Fluorescence Imaging Using Point Spread Functions and Other Techniques,” by Zhuang, et al.; and U.S. Provisional Patent Application Ser. No. 61/938,089, filed Feb. 10, 2014, entitled “Three-Dimensional Super-Resolution Fluorescence Imaging Using Point Spread Functions and Other Techniques,” by Zhuang, et al. The following examples are intended to illustrate certain embodiments of the present invention, but do not exemplify the full scope of the invention.

### EXAMPLE 1

Airy beams and related waveforms maintain their intensity profiles over a large propagation distance without substantial diffraction, and may exhibit lateral bending during propagation. This example introduces a self-bending point spread function (SB-PSF) based on Airy beams for three-dimensional (3D) super-resolution fluorescence imaging. In this example, a side-lobe-free SB-PSF was designed for fluorescence emission and implemented in a two-channel detection scheme for the SB-PSF to enable unambiguous 3D localization of fluorescent molecules. The lack of diffraction and the propagation-dependent lateral bending make the SB-PSF ideal for precise 3D localization of molecules over a large imaging depth. Using this SB-PSF, super-resolution imaging was demonstrated with isotropic localization precisions of 10-15 nm in all three dimensions over a 3 micrometer imaging depth without sample scanning.

This example describes a localization method that provides an isotropic 3D resolution and a large imaging depth. This approach to localization of individual fluorophores provides both an isotropically high 3D localization precision and a large imaging depth. As mentioned, this approach is based on a self-bending point spread function (“SB-PSF”) derived from nondiffracting Airy beams. Unlike standard Gaussian beams, nondiffracting beams such as Bessel beams and Airy beams propagate over many Rayleigh lengths without appreciable change in their intensity profiles, and are self-healing after being obscured in scattering media. Unique among the non-diffracting beams, Airy beams and related waveforms may undergo lateral displacement as they propagate along the optical axis, resulting in bending light paths. The propagation distance of an Airy beam along the axial direction, and hence the axial position of an emitter, can be determined from the lateral displacement of the beam, provided that there is a way to distinguish the lateral position of the emitter from the lateral displacement of the self-bending beam due to propagation.

Airy beams can be generated based on the consideration that a 2D exponentially truncated Airy function Ai(x/a₀, y/a₀) is the Fourier transform of a Gaussian beam A₀ exp[(−(kₓ²+k_{y}²)/w₀)] modulated by a cubic spatial phase, where (x , y) and (kₓ,k_{y}) are conjugate variables for position and wavevector, respectively. Light emitted from a point source after imaging through a microscope can be approximated by a Gaussian beam. Hence, fluorescence emissions from individual molecules can be converted into Airy beams if a cubic spatial phase with a spatial light modulator (SLM) placed at the Fourier plane is introduced in the detection path of the microscope (FIGS. 1A, 5, and 6). Here, the cubic function ((kₓ+k_{y})/b₀)³+((−kₓ+k_{y})/b₀)³ was used for the spatial phase modulation such that the bending of light occurred in the x direction. In order to separate first-order (desired) of diffracted light from the unmodulated, zeroth-order beam, an additional diffraction grating was added to the phase pattern on the SLM.

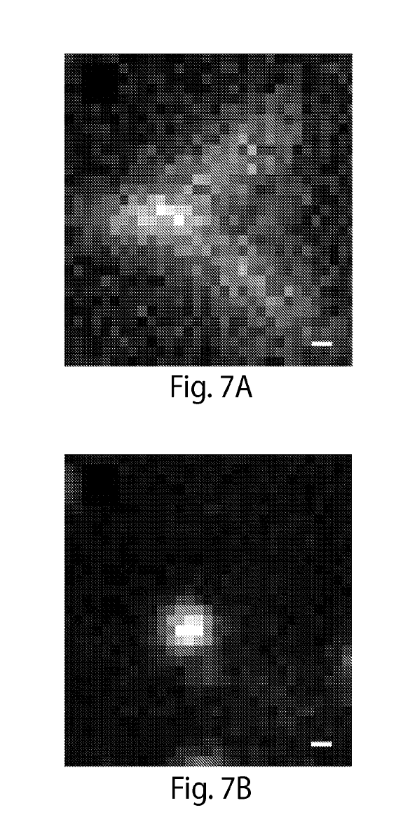

To facilitate precise 3D localization of the emitters, two important variations to the Airy beam generated based on the above scheme were introduced. First, the conventional implementation of the Airy beams using the cubic spatial phase alone lead to large side-lobes that not only hinder accurate localization of individual emitters but also prevent imaging densely labeled samples because each PSF occupies a large area (FIG. 7). In order to eliminate these side-lobes, spatial apodization was exerted in the Fourier space by introducing an additional phase modulation on the SLM to divert all wavevectors with the y component greater than a cutoff value (i.e. |k_{y}|>k_{yc}) out of the detection path (FIG. 6). The parameters in the cubic phase and the cutoff value k_{yc} were optimized to reduce the Airy beam side-lobes while still preserving 70-80% of photons (FIGS. 6 and 7).

Second, the unpolarized fluorescence emission was split into two orthogonally polarized beams and one of the polarizations was rotated such that both beams were properly polarized for the polarization-dependent SLM. This two-beam design not only reduced photon losses due to the SLM but also allowed the two beams to be separately directed so that they bent in opposite directions during propagation, which is used for decoupling the lateral position of the emitter from propagation-induced lateral displacement of the beam. Specifically, the lateral position of the emitter was determined from the average peak position of the two beams and the lateral bending of the PSF from the separation between the two peak positions.

FIG. 6 shows the phase pattern used to generate the SB-PSF in this example. The 256×256 pixel grayscale image shows the phase modulation that was programmed on the SLM to generate the SB-PSF, with white to black colors denoting gradual phase modulation from 0 to 2π (2 pi). Dashed and dotted circles mark approximate areas of the incoming fluorescence light in the left (L) and right (R) channels, respectively. The cubic phase pattern is generated from the expression:

P(kₓ,k_{y})=A[(kₓ+k_{y})³+(−kₓ+k_{y})³]+Bkₓ²+Ck_{y}²,

where (kₓ,k_{y}) are pixel numbers between [427, 128], A is the coefficient of the cubic phase term, which determines the self-bending property, the terms (kₓ+k_{y})³ and (−kₓ+k_{y})³ ensure that the beam bends along the x direction, and B and C can be independently used to compensate any distortions in the profile of the PSF, which may be induced by astigmatism in the optical system or anisotropy of the Airy beam. B and C can also be used to adjust the focal position and compensate any propagation length difference in the two polarization channels (termed the L and R channels).

Experimentally, the values of A, B, and C were adjusted to optimize the performance of the PSF in terms of bending angle, imaging depth and focal position. The optimal values were found in this example to be A=10⁻⁶, B=C=−10⁻³. B and C were not further adjusted to compensate for astigmatism or other beam distortions because the image quality was already adequate. To remove the side-lobes in the SB-PSF, the phase pattern was then truncated at |k_{y}|>k_{yc}, beyond which it was replaced by linear spatial phase gratings in the L and R channels, and hence wavevectors with |k_{y}|>k_{yc} were not detected. Because wavevectors |k_{y}|>k_{yc} are primarily responsible for the side-lobes in an Airy beam generated by the pure cubic spatial phase, removal of these wavevectors, in addition to the optimization of the cubic phase, largely eliminated the side-lobes in the SB-PSF and greatly improved the imaging performance (see FIG. 7). To separate the above side-lobe-free SB-PSF (first-order diffraction) from unmodulated copropagating beam (zeroth-order diffraction), in experiment, additional linear phase gratings (not shown here) were added to the phase pattern shown here, with which different orders of diffractions were deflected at different angles (as shown in the inset of FIG. 5).

FIG. 7 shows measured transverse profiles of the SB-PSFs generated using the phase masks without and with the additional phase modulation to remove the side-lobes. FIG. 7A shows the transverse profiles of the SB-PSF generated with a SLM that imparted the full cubic phase on the fluorescence emission (phase pattern not shown). FIG. 7B shows the transverse profiles of the SB-PSF generated with a SLM that imparted the truncated cubic phase, which directed the wavevectors |k_{y}|>k_{yc} out of the detection path (phase pattern shown in FIG. 6). The PSF was recorded as the images of 100 nm fluorescent microspheres. The Airy beam generated by the new phase modulation shown in FIG. 6 eliminated the side-lobes, and thereby substantially improved the peak contrast and profile of the PSF and the localization precision of individual emitters. Scale bars, 300 nm.

To test the performance of the SB-PSF, 100 nm fluorescent beads were used as point emitters and their images recorded in the two polarization channels, denoted as left (L) and right (R) channels using a configuration as described above (see FIGS. 1 and 5).

It is worth noting that the PSF tends to bend in the same direction above and below the focal plane. Thus, only one side of the focal plane was selected for imaging to avoid ambiguity. In addition, the refractive index mismatch between the sample and the oil-immersion lens causes spherical aberration, which results in a deviation of the observed axial position of the emitter from the real position. Although this deviation can be corrected by a rescaling factor, the localization precision deteriorates as the rescaling factor increases. Considering that the spherical aberration is larger for emitters above the focal plane than below the focal plane, only imaging below the focal plane was performed in this example. To ensure this condition, the bead sample was initially placed at the focal plane and then scanned towards the objective along the axial (z) direction. As the sample was translated in z, the images of individual beads in the two channels shifted laterally in opposite directions in x (FIG. 1B). The SB-PSF maintained a compact profile over a ˜3 micrometer range, expanding only 2.4 times in width (FIG. 1B). In contrast, images of the beads recorded without using the SLM, i.e. in the form of a standard Gaussian (or Airy-disk to be exact) PSF expanded by more than 15 times over the same z range, and became barely detectable when placed more than 500 nm from the focal plane (FIG. 1B). Measurement of the lateral bending of the SB-PSF as a function of axial displacement (FIG. 1C) was in good agreement with numerical simulation results (FIG. 1D; see below for simulation details).

A calibration curve was then generated that allowed determination of the 3D coordinates of the emitters by relating the known axial (z) positions of the bead sample to the observed lateral bending Δx=(x_{R}−x_{L})/2 of the bead images, where x_{R} and x_{L} represent the peak positions of the bead images along the x direction in the R and L channels, respectively (FIG. 1E). Notably, in spite of the removal of the side-lobes of the Airy beam and the use of incoherent fluorescence light, the observed lateral bending magnitude agreed well with the prediction based on a coherent Airy beam

$$Δ x = \frac{1}{2 \sqrt{2} {k}^{2} {x}_{0}^{3}} {z}^{2} ,$$

where k is the wavenumber, x, describes the transverse size of the beam (see below). For any emitter, its transverse coordinates (x , y) could be determined from the average centroid positions of the two images in the L and R channels, i.e., (x, y)=((x_{L}+x_{R})/2, (y_{L}+y_{R})/2), and its z from Δx=(x_{R}−x_{L})/2 using the calibration curve.

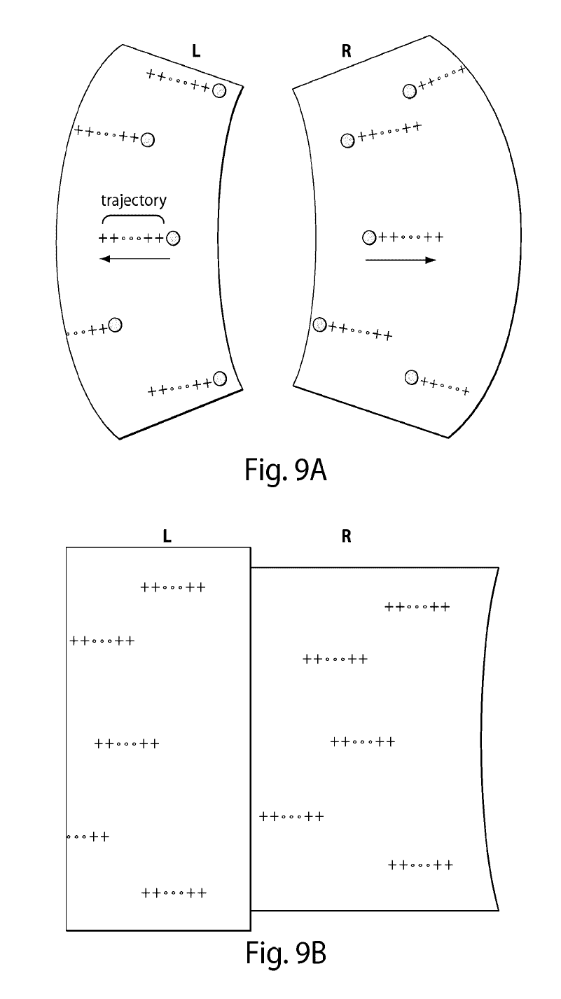

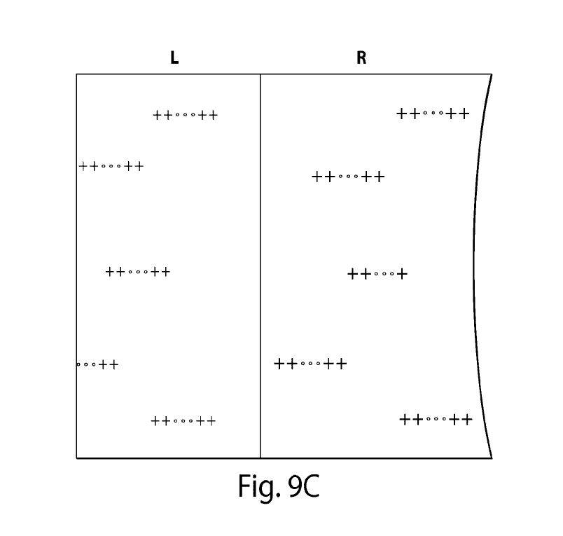

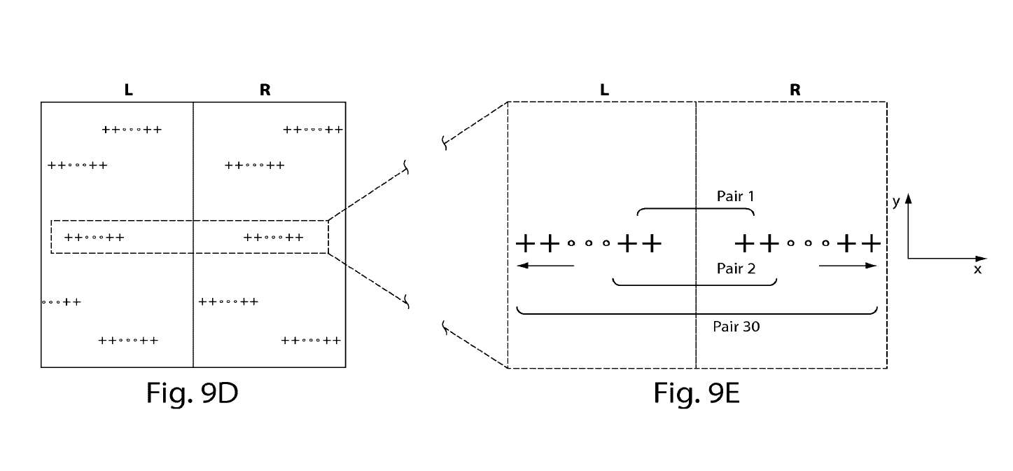

FIG. 1 shows the self-bending point spread function (SB-PSF) based on an Airy beam. FIG. 1A shows a schematic of the experimental setup used to generate the SB-PSF. The sample was illuminated by excitation (647 nm) and photoactivation (405 nm) lasers during image acquisition. The objective lens (OL) and tube lens (TL) form an image of the sample at an intermediate plane (black dashed line), which is relayed to the EMCCD (Electron Multiplying CCD) camera by the relay lenses (RL1 and RL2). The spatial light modulator (SLM) situated at the focal plane of RL1 and RL2 imparts a phase modulation that converts the emission into the desired SB-PSF with lateral bending that depends on the axial propagation distance. The emission is split into two polarizations by a polarizing beam splitter (PBS), one of which is rotated by a half-wave plate (λ/2), such that the polarizations of both beams are aligned along the active polarization direction of the SLM. DC: dichroic cube (including excitation filter, dichroic mirror, and emission filter); M: mirror. FIG. 1B shows the x-y cross-sections of the SB-PSF (left and middle panels) and the standard Gaussian PSF (right panels) at several axial positions over a 3 micrometer z range. The PSFs were recorded as the images of fluorescence microspheres as they were translated in the axial direction. FIG. 1C shows x-z views of the SB-PSF (left and middle panels) and the standard Gaussian PSF (right panel). The PSFs were generated from the images of fluorescence microspheres as in FIG. 1B. FIG. 1D shows the corresponding x-z views of the SB-PSF and the standard Gaussian PSF obtained from numerical simulation. FIG. 1E shows the calibration curve of the lateral bending distance, Δx=(x_{R}−x_{L})/2, as a function of the axial positions of the emitters, obtained by recording the images of fluorescence microspheres at different z positions. FIG. 1F shows the x (upper panel) and y (lower panel) positions of a fluorescence microsphere measured at various axial positions of the sample before (open symbols) and after (closed symbols) the L/R channel alignment procedure described with respect to FIG. 9. The standard deviation of the x-y positions was <8 nm over the entire 3 micrometer imaging depth after channel alignment. Scale bars, 500 nm.

FIG. 9 shows procedures for calibration and alignment of the L and R channels. FIG. 9A shows a sketch of the field of view shown in the L and R channels on the camera and the beads imaged in the two channels. In these experiments, there were more than 100 beads uniformly distributed in the field of view. The sample stage was first placed at focal plane, where identical images were recorded in the two channels (images of beads indicated by the gray circles). As the sample was translated axially in 100 nm steps over a >3 micrometer range, the bead images in the two channels moved in approximately opposite directions as indicated by the arrows. At each height, positions of beads were marked as “+”. Each bead thus had a trajectory of positions as a function of axial positions of the sample. Due to aberrations in the optical system, these lateral trajectories were slightly tilted from expected x direction, leading to two slightly curved fields of view for the L and R channels after all bead positions recorded at different axial sample positions were stacked (the tilt angles are exaggerated for illustration purposes).

FIG. 9B shows that two curved fields of view were first straightened using third-order polynomial transformations. These transformations keep the lengths of all bead trajectories unchanged but only rotate the angles of the trajectories. These third-order polynomial transformation matrices are referred to as rotation matrices (RM). FIG. 9C the y positions of the beads in one channel was then mapped to their corresponding trajectories in the other channel with another third-order polynomial mapping matrix, referred to as the vertical matrix (VM). FIG. 9D shows that next, an additional third-order polynomial mapping matrix was applied to make the bending magnitude, i.e. x displacement versus axial positions, uniform (equal to an average bending magnitude) among all beads and symmetric between the L and R channels. This third-order polynomial mapping matrix is referred to as a horizontal matrix (HM). FIG. 9E shows that the resulting bending distances (Δx=(x_{R}−x_{L})/2) as a function of the axial positions of the sample were used to generate the calibration curve shown in FIG. 1E. Here, only the pair of trajectories for one bead is illustrated, with pairs 1, 2 and 30 referring to the pairs of bead positions in the Land R channels at axial positions 1, 2 and 30. For STORM imaging, the above calibration process was done prior to STORM image acquisition. For analysis of STORM data, RMs, VM and HM were first applied to drift corrected molecule lists and the calibration curve was used to determine axial positions of individual molecules.

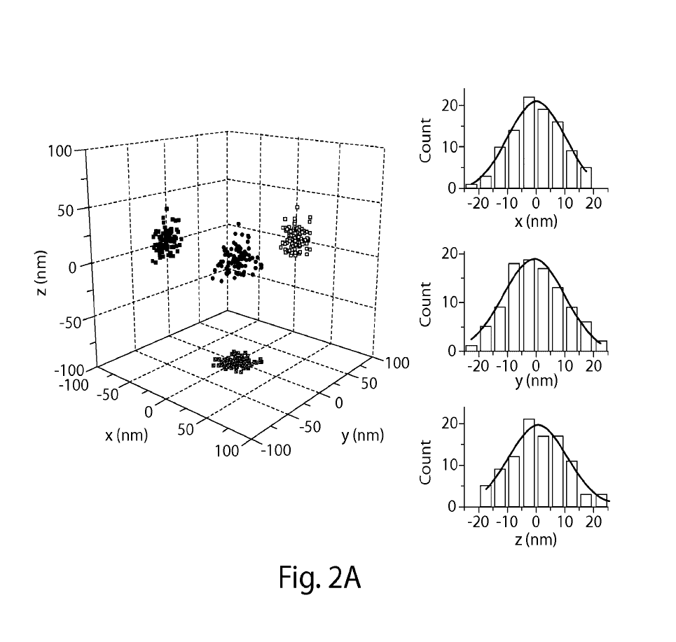

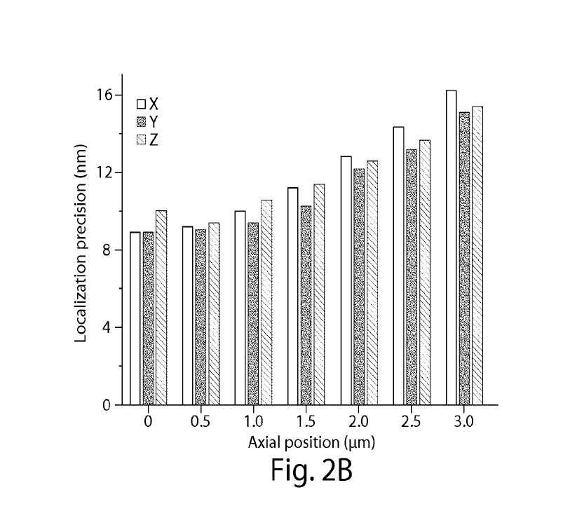

To characterize the 3D localization precisions using this SB-PSF, individual molecules of Alexa 647, a photoswitchable dye, were imaged immobilized on a glass surface. The dye molecules were switched on and off for multiple cycles, and the localization precisions were determined from the standard deviation (SD) of repetitive localizations of each molecule (FIG. 2A). At the focal plane (z=0), the SD of the localization distributions of individual molecules were 9.2 nm, 8.9 nm, and 10.0 nm in x, y and z , respectively (FIG. 2A). The corresponding full width at half maximum (FWHM) values, which describes how far the two molecules need to be in order for their images to be unambiguously resolved, were 21.6 nm, 20.9 nm, and 23.5 nm (FWHM=2.35×SD). Notably, the localization precisions were isotropic and did not change rapidly with the axial position of the molecules. Over a 3 micrometer axial range below the focal plane, the localization precisions only changed by 1.8 fold from ˜9 nm to ˜16 nm in all three dimensions (FIG. 2B).

FIG. 2 shows the three-dimensional localization precision of single fluorescent molecules using the SB-PSF. FIG. 2A shows that repetitive activation gives a cluster of localizations for each individual molecule. Multiple clusters were aligned by their centers of mass to generate the overall 3D localization distribution (left). The right panels show the distributions in x (top), y (middle), and z (bottom). The distributions were fit to a Gaussian function (black line), yielding standard deviations of 9.2 nm, 8.9 nm and 10.0 nm along x, y and z, respectively, for molecules at the focal plane (z near zero). FIG. 2B shows that the localization precision values determined at various axial (z) positions over a 3 micrometer range. The white, grey and light grey bars indicate localization precisions in the x, y and z directions, respectively.

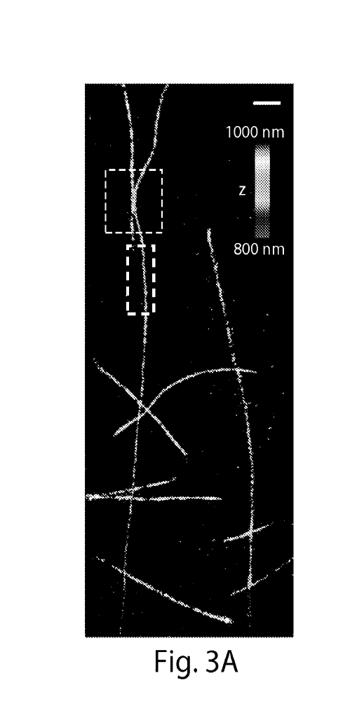

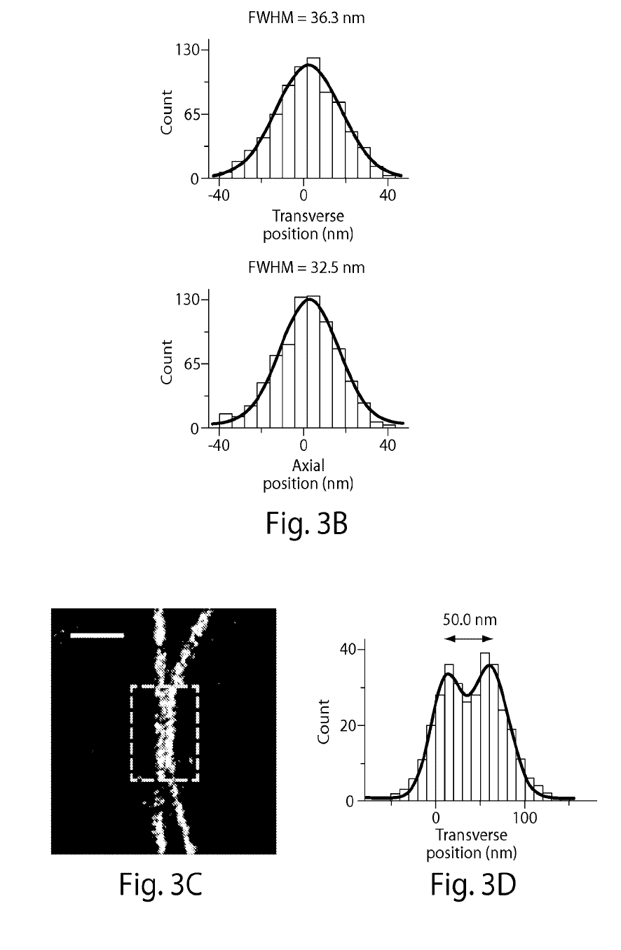

Next, the use of this SB-PSF was demonstrated for super-resolution STORM imaging of biological samples. To record the STORM images, only a small fraction of the photoswitchable dyes were activated at a time such that they were optically resolvable. Imaging the activated dye molecules using the SB-PSF allowed for high-precision 3D localization of individual molecules. Iteration of the activation, imaging, and localization procedure then allowed numerous dye molecules to be localized and a super-resolution image to be constructed from the localizations. In vitro polymerized microtubules were first imaged. FIG. 3A shows a 3D STORM image of microtubule directly labeled with a HyLite 647 dye (a structural analog of Alexa 647). Both lateral and axial cross-sectional profiles of the microtubules gave consistent, isotropic 3D widths of ˜35 nm (FIG. 3B), which is in agreement with the known ˜25 nm diameter of microtubules after broadening by the image resolution. Microtubule filaments separated by ˜50 nm were well resolved (FIGS. 3C, 3D).

FIG. 3 shows STORM imaging of in vitro polymerized microtubules using the SB-PSF. FIG. 3A shows a 3D STORM image of in vitro assembled microtubules, with z positions coded according to the grayscale bar. FIG. 3B shows that the left and right panels show the transverse (x) and axial (z) cross-sectional profiles of a 2 micrometer segment outlined in the lower box, respectively. The profiles exhibit isotropic FWHM of 36.3 nm and 32.5 nm, respectively. FIG. 3C shows a zoom-in image of the upper boxed region in FIG. 3A. FIG. 3D shows a transverse cross-sectional profile of the two nearby microtubules shown in the boxed region in FIG. 3C. Scale bars, FIG. 1A, 1 micrometer, FIG. 1C, 500 nm.

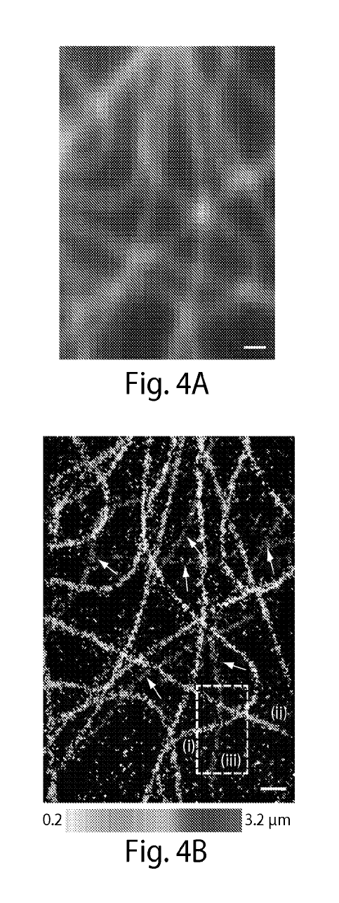

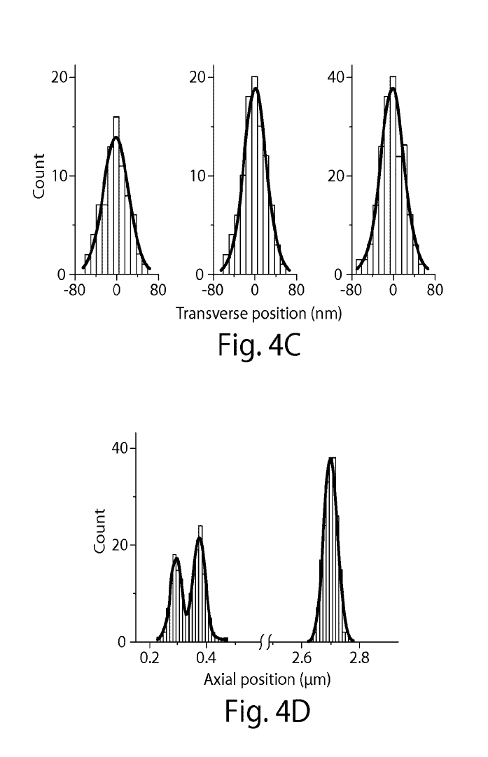

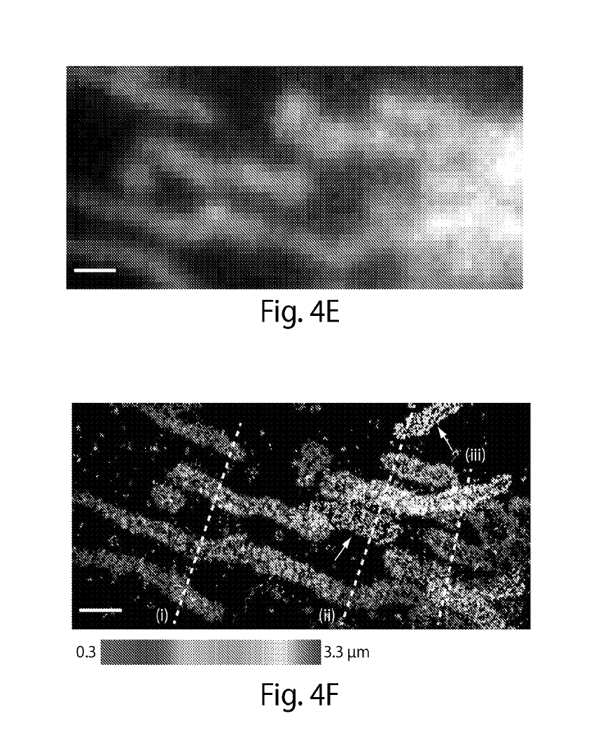

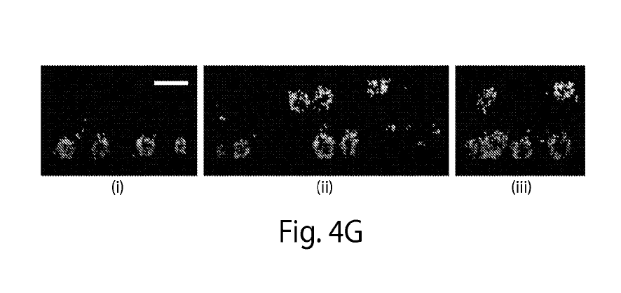

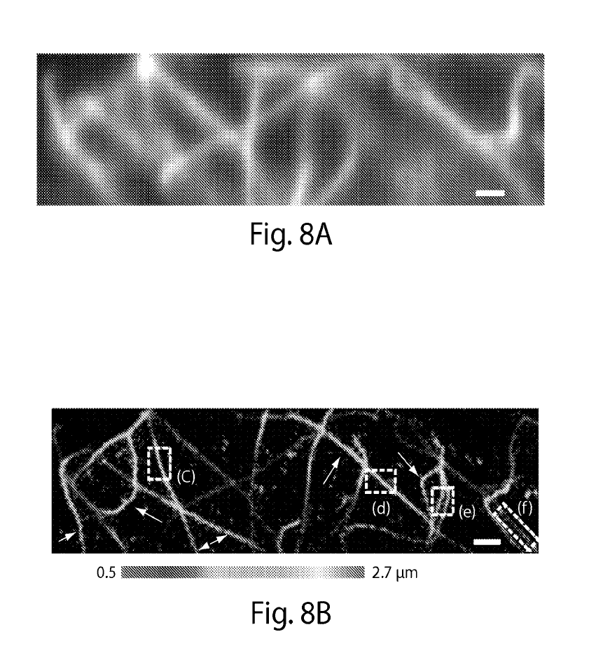

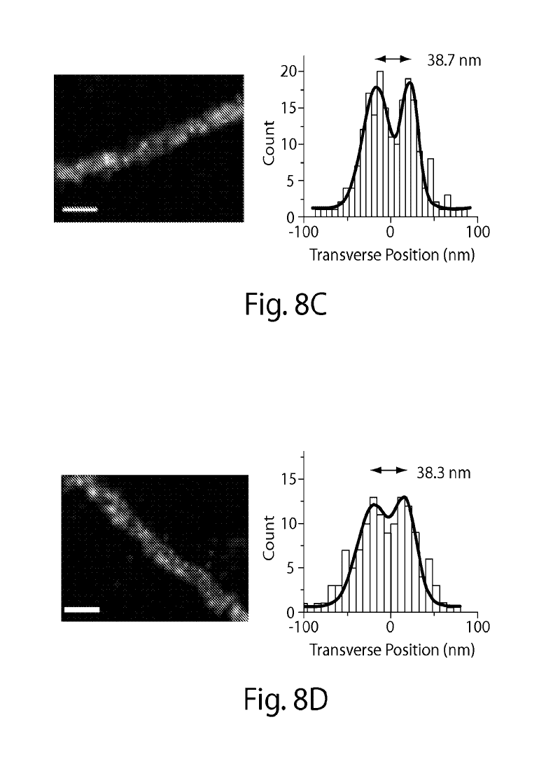

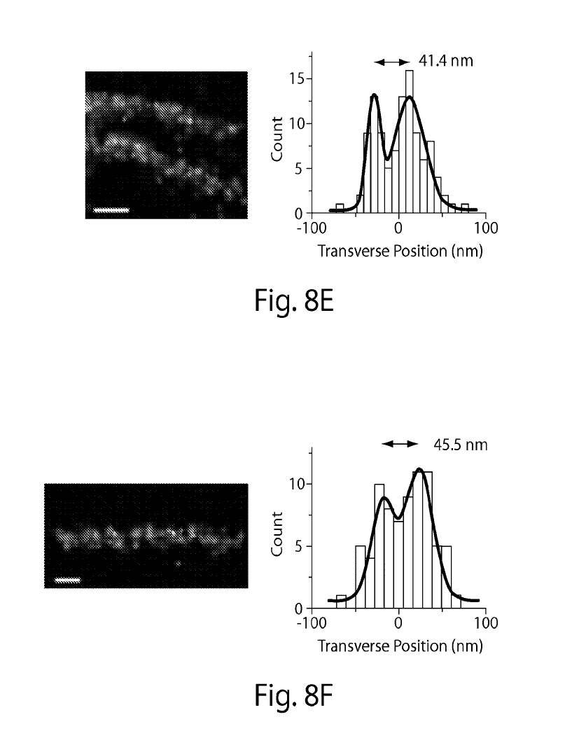

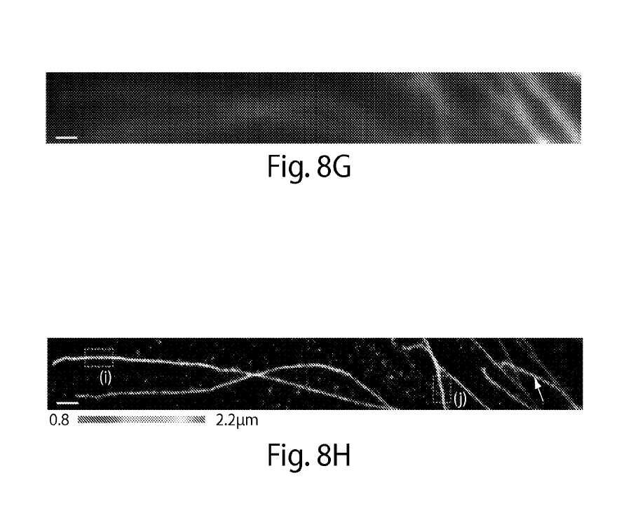

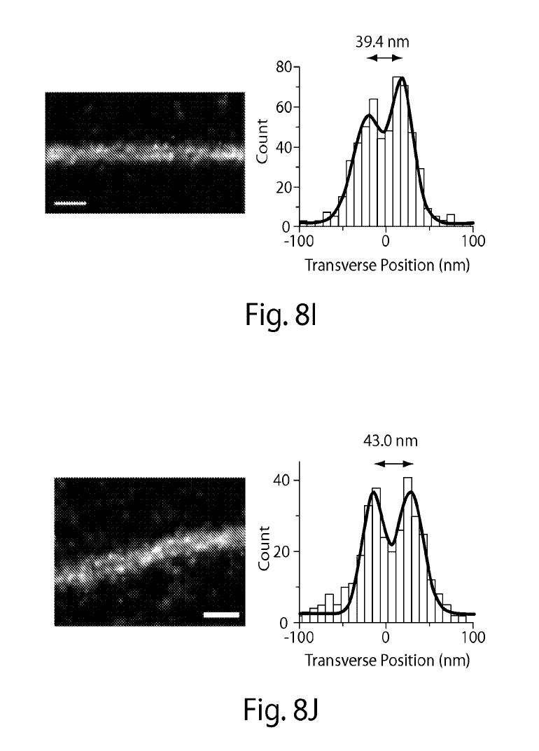

STORM images were also recorded of immunolabeled microtubules and mitochondria in mammalian (BS-C-1) cells using the SB-PSF and compared the results with conventional images taken using the standard Gaussian PSF without any modulation at the SLM (FIGS. 4 and 8). Remarkably, the super-resolution images not only exhibited substantially higher resolution than the conventional images, but also captured microtubules and mitochondria that were completely undetectable in the conventional images due to severe diffraction of out-of-focus light of the Gaussian PSF (examples indicated by white arrows in FIGS. 4B, 4F, 8B, and 8H). While conventional images captured features over only a thin slice (˜1 micrometer) of the sample (FIGS. 4A and 4E), STORM images taken with the SB-PSF maintained a high, isotropic 3D resolution over a ˜3 micrometer range without the need of any sample or focal-plane scanning (FIGS. 4B and 4F).

As an example, FIGS. 4C and 4D show the transverse and axial profiles of three microtubules spanning a ˜2.5 micrometer axial range. All three immunolabeled microtubules had nearly isotropic widths of 50-60 nm, which may be expected for microtubules that are broadened by immunolabeling with primary and secondary antibodies. Using a recently optimized labeling protocol to increase the label density, the hollow structures of the immunolabeled microtubules were also observed (FIGS. 4C-4F, 41, and 4J), consistent with previous results. Similarly, high-quality STORM images over ˜3 micrometer z range were acquired for mitochondria using the SB-PSF. The hollow outer-membrane structure of mitochondria was clearly observable throughout this range (FIG. 4G).

FIG. 4 shows STORM imaging of microtubules and mitochondria in cells using the SB-PSF. FIG. 4A shows a conventional immunofluorescence image of microtubules in a BS-C-1 cell taken with the standard Gaussian PSF. FIG. 4B shows the 3D STORM image of the same area taken with the SB-PSF. The z-position information are coded according to the grayscale bar. White arrows indicate microtubules that are undetectable in the conventional image but are captured in the STORM image. FIG. 4C shows, from left to right, transverse cross-sectional profiles of the three microtubule filaments (i), (ii) and (iii) in the boxed region in FIG. 4B, respectively. The FWHM of the three peaks were 52.1 nm, 55.9 nm and 53.5 nm, respectively. FIG. 4D shows axial cross-sectional profiles of the same microtubules. The FWHM of the three peaks were 52.4 nm, 50.8 nm and 58.0 nm, respectively. FIG. 4E shows a conventional immunofluorescence image of mitochondria in a BS-C-1 cell taken with the standard Gaussian PSF. FIG. 4F shows the 3D STORM image of the same area taken with the SB-PSF. White arrows indicate mitochondria that were not detected in the conventional image, but were captured in the STORM image. FIG. 4G shows the cross-sections along the dashed lines (i), (ii) and (iii) in FIG. 4F, showing the hollow outer-membrane structures of mitochondria. Scale bars, FIGS. 4A-4B, 500 nm, FIGS. 4E-4G, 1 micrometer.

In summary, this example illustrates a SB-PSF based on an Airy beam for precise 3D localization of individual fluorophores. When combined with STORM, this SB-PSF allows for super-resolution imaging with an isotropically high resolution in all three dimensions over an imaging depth of several microns without requiring any sample or focal plane scanning The resolution provided by SB-PSF is higher than previous 3D localization approaches using PSF engineering, especially in the z direction. Because of the non-diffracting nature of the Airy beam, the imaging depth of the SB-PSF approach is larger than previous 3D localization methods. Although the imaging depth of other 3D localization methods can be increased by performing z- scanning to include multiple focal planes, the localization density and hence the effective image resolution can decrease considerably due to z-scanning because of the photobleaching-induced fluorophore depletion problem—i.e. simultaneously as the fluorophores in one focal plane are imaged, the fluorophores in the other planes are activated and bleached. The SB-PSF approach would thus be particularly useful for high-resolution imaging of relatively thick samples. The relatively large area of the SB-PSF, as compared to the simple PSF shapes (e.g. in astigmatism imaging), may reduce the number of localizable fluorophores per imaging frame and hence reduce the imaging speed moderately.

The image resolution afforded by the SB-PSF, like other single-molecule localization approaches, depends on the number of photons detected from individual fluorophores. In this work, the phase modulation by SLM leads to two photon-loss mechanisms (see below). First, phase wrapping (i.e., modulo 2π (pi)) on the pixelated SLM resulted in multiple orders of diffraction. Since only the first-order diffraction is used to generate the self-bending beam, the 50% of light distributed in the unmodulated (zeroth-order) component and higher-order diffractions is lost. Second, of the remaining 50% of light, 70-80% was retained after removal of side lobes. Therefore, while 5000-6000 photons were detected per switching cycle of Alexa 647 when SLM was not used, only ˜2000 photons were detected here. It should be noted that the photon loss due to the pixelation of SLM can be largely reduced by using a continuous phase mask fabricated using grayscale photolithography, further improving the image resolution. Moreover, the SB-PSF approach may be fully compatible with the recently reported dual-objective detection scheme (see International Patent Application No. PCT/U52012/069138, filed Dec. 15, 2012, entitled “High Resolution Dual-Objective Microscopy,” by Zhuang, et al., published as WO 2013/090360 on Jun. 20, 2013, incorporated herein by reference) or ultra-bright photoactivatable fluorophores, which should further increase the number of photons detected and allow for even higher image resolutions. Other factors in addition to the photon number, such as the density, size and dipole orientation of the fluorescent labels can also affect the overall image resolution. It is expected that improvements in these aspects to be also compatible with the SB-PSF approach for providing ultrahigh and isotropic 3D image resolution over a large imaging depth.

The following are materials and methods used in this example.

Optical setup. All measurements were performed on a home-built inverted microscope (FIG. 5) configured for either total internal reflection fluorescence (TIRF) or oblique incidence excitation. The microscope utilized a 100×, 1.4 NA oil-immersion objective lens (Olympus UPlanSApo 100×, 1.4 NA) mounted beneath a three-axis nanopositioning system (Nano-LPS100, Mad City Labs), which controls the position of the sample. Activation of the Alexa 647 or HyLite 647 dye was provided by a 405 nm solid-state laser (CUBE, Coherent) and excitation of the activated dye molecules was provided by a 647 nm krypton gas laser (Innova 70C, Coherent). A 660 nm longpass dichroic minor (Z660DCXRU, Chroma) was used to reflect the 405 nm and 647 nm lasers, and the transmitted fluorescence light was passed through a 700/75 emission filter (ET700/75m, Chroma). A 200 mm achromatic doublet lens (Thorlabs) functioned as a tube lens and formed an intermediate image plane situated at the input of the SB-PSF module. The SB-PSF module included a two-channel 4-f imaging system with a programmable spatial light modulator (SLM, Custom XY Nematic Series, Boulder Nonlinear Systems) located at the Fourier plane. The emission light was split into two orthogonal polarizations, which were then directed with mirrors onto different regions of the 256×256 pixel display of the SLM. Since the SLM can only modulate light with a defined polarization, the polarization of one beam was rotated 90° by a half-wave plate prior to impinging upon the SLM. Finally, the two beams reflected off the SLM, denoted as the left (L) and right (R) channels, were recorded on the left and right halves of an electron-multiplying CCD camera (iXon897, Andor), respectively.

FIG. 5 shows a detailed schematic of the optical setup. The set-up was built on a 60 cm×60 cm breadboard using a compact design. In the excitation path, the size of the laser beam is adjusted by an iris and collimated by relay optics. Mirrors M1 and M2 were translated by a translation stage in order to control the incidence angle between the epi-illumination and TIRF geometry. In the detection path, a polarizing beam splitter PBS1 first separated the emission into two polarizations, which were mixed and broadened by RL1 and again separated by a second polarizing beam splitter PBS2.

Experimentally, it was found that slightly deviating the two beams off the center of lens RL1 helped enlarge the bending angle. Minors (M5, M7) and (M4, M6, M8) independently directed each beam. Because the spatial light modulator (SLM) was polarization dependent, the polarization of one of the beams was rotated by a half-wave plate (λ/2) such that both beams were polarization-aligned with the active polarization direction of the SLM. The two beams were launched at different incident angles on the SLM, resulting in slight difference in beam profiles, which were compensated during the channel alignment between the two channels (see FIG. 9). D-shaped mirrors M6, M9, and M10 were used to allow space for two approaching beams. Mirrors M9, M10, M11, and M12 were used to project two beams onto separate regions of the EMCCD. The optical path lengths of the beams were adjusted to be identical in each section between the tube lens TL (200 mm achromatic doublet lens) and the relay lens RL1 (200 mm achromatic doublet lens), between RL1 and SLM, between SLM and another relay lens RL2 (200 mm achromatic doublet lens), and between RL2 and EMCCD. Any difference was compensated by an additional parabolic phase on the SLM so that the same plane in the sample was in focus on the EMCCD in the two channels. Exc. (Em.) Filter, excitation (emission) filter. DC, dichroic minor. The inset shows the divergence of different orders of diffraction on the SLM. The first-order diffraction beam was directed to the imaging path, whereas the zeroth-order diffraction was deviated and blocked from the detection path.

Sample preparation for single-molecule characterization. Characterization of the localization precision of single molecules was performed using Alexa 647-labeled donkey anti-rat secondary antibodies. In brief, all dye-labeled antibodies for single-molecule characterization measurements used dye-labeling ratios <1 dye per antibody on average such that most labeled antibody have 1 dye per antibody molecule. Labeled antibodies were immobilized on the surface of LabTek 8-well coverglass chambers. Chambers were pre-cleaned by sonication for 10 min in 1 M aqueous potassium hydroxide, washing with Mili-Q water and blow-drying with compressed nitrogen. Labeled antibodies were adsorbed to the coverglass at a density of ˜0.1 dye micrometer⁻2 such that individual dye molecules could be clearly resolved from each other. To assist drift correction during acquisition, fiducial markers (0.2 micrometer orange beads, F8809, Invitrogen) were loaded to chambers at a final density of ˜0.01 microspheres/micrometer² prior to sample preparation.

In vitro assembled microtubule preparation. In vitro assembled microtubules were prepared according to the manufacturer's protocol (Cat. # TL670M, Cytoskeleton Inc.). In brief, prechilled 20 microgram aliquots of HiLyte 647-labeled tubulin (Cat. # TL670M) were dissolved in 5 microliters of a prechilled microtubule growth buffer (100 mM PIPES, pH 7.0, 1 mM EGTA, 1 mM MgCl_{2,} 1 mM GTP (BST06, Cytoskeleton), and 10% glycerol (v/v)). After centrifugation for 10 min at 14,000 g at 4° C. to pellet any initial tubulin aggregates, the supernatant was incubated at 37° C. for 20 min to polymerize microtubules. A stock solution of paclitaxel (TXD01, Cytoskeleton) in DMSO was added to the polymerized microtubules to a final concentration of 20 micromolar and incubated at 37° C. for 5 min to stabilize the microtubules. The sample was then stored at 23° C. in the dark. For imaging, 0.2 microliters of the stabilized microtubule stock was diluted into 200 microliters of 37° C. microtubule dilution buffer (100 mM PIPES pH 7.0, 1 mM EGTA, 1 mM MgCl_{2,} 30% glycerol, and 20 micromolar paclitaxel), incubated for 5 min in silanized LabTek 8-well chambers (see below) which facilitated microtubule sticking, fixed for 10 min in microtubule dilution buffer fortified with 0.5% glutaraldehyde, and washed 3 times with phosphate-buffered saline (PBS). Prior to use, the LabTek 8-well chambers had been cleaned using the same procedure described above, silanized by incubation with 1% N-(2-aminoethyl)-3-aminopropyl trimethoxysilane (UCT Specialties), 5% acetic acid and 94% methanol for 10 min, and washed with water. Fiducial markers were added to the sample using the same procedure described above.

Immunofluorescence staining of cellular structures Immunostaining was performed using BS-C-1 cells (American Type Culture Collection) cultured with Eagle's Minimum Essential Medium supplemented with 10% fetal bovine serum, penicillin and streptomycin, and incubated at 37° C. with 5% CO₂. Cells were plated in LabTek 8-well coverglass chambers at ˜20,000 cells per well 18-24 hours prior to fixation. The immunostaining procedure for microtubules and mitochondria included fixation for 10 min with 3% paraformaldehyde and 0.1% glutaraldehyde in PBS, washing with PBS, reduction for 7 min with 0.1% sodium borohydride in PBS to reduce background fluorescence, washing with PBS, blocking and permeabilization for 20 min in PBS containing 3% bovine serum albumin and 0.5% (v/v) Triton X-100 (blocking buffer (BB)), staining for 40 min with primary antibody (rat anti-tubulin (ab6160, Abcam) for tubulin or rabbit anti-TOM20 (sc-11415, Santa Cruz) for mitochondria) diluted in BB to a concentration of 2 microgram/mL, washing with PBS containing 0.2% bovine serum albumin and 0.1% (v/v) Triton X-100 (washing buffer, WB), incubation for 30 min with secondary antibodies (˜1-2 Alexa 647 dyes per antibody, donkey anti-rat for microtubules and donkey anti-rabbit for mitochondria, using an antibody labeling procedure) at a concentration of ˜2.5 microgram/mL in BB, washing with WB and sequentially with PBS, postfixation for 10 min with 3% paraformaldehyde and 0.1% glutaraldehyde in PBS, and finally washing with PBS. For high-density labeling performed in FIG. 8, the immunostaining procedure for microtubules included washing with PBS, extraction for 1 min with 0.2% Triton X-100 in a pH 7 buffer consisting of 0.1 M PIPES, 1 mM ethylene glycol tetraacetic acid, and 1 mM magnesium chloride, fixation for 10 min with 3% paraformaldehyde and 0.1% glutaraldehyde in PBS, reduction for 5 min with 0.1% sodium borohydride in water, washing with PBS, blocking and permeabilization for 30 min with BB, staining for 40 min with primary antibody (rat anti-tubulin (ab6160, Abcam) diluted to 10 microgram/mL in BB, washing with PBS, staining for 60 min with a custom-labeled donkey anti-rat secondary antibodies bearing 1.7 Alexa 647 dyes per antibody diluted to 2.5 microgram/mL in BB, washing with PBS, postfixation for 10 min with 3% paraformaldehyde and 0.1% glutaraldehyde in PBS, and finally washing with PBS.

FIG. 8 shows STORM imaging of microtubules in cells using SB-PSF and high-density labeling protocol. Images for two different cells are shown in FIGS. 8A-8F and FIGS. 8G

8J, respectively. FIGS. 8A and 8G show conventional immunofluorescence images of microtubules in a BS-C-1 cell taken with the standard Gaussian PSF. FIGS. 8B and 8H show the 3D STORM images of the same areas in FIGS. 8A and 8G, respectively, taken with the SB-PSF. The z-position information are coded according to the grayscale bars. White arrows indicate microtubules that are undetectable in the conventional images in FIGS. 8A and 8G but are captured in the STORM images in FIGS. 8B and FIGS. 8H, respectively. FIGS. 8C-8F are zoom-in images and transverse cross-sectional profiles of microtubules in the boxed regions in FIG. 8B. In FIG. 8E, the cross-sectional profile was taken on the bottom microtubule filament. Hollow microtubule structures were well-resolved and the distances between peaks were 38.7 nm, 38.3 nm, 41.4 nm, and 45.5 nm, respectively. FIGS. 8I and 8J are zoom-in images and transverse cross-sectional profiles of microtubules in the boxed regions in FIG. 8H. Hollow microtubule structures were well-resolved and the distances between peaks were 39.4 nm and 43.0 nm, respectively. All zoom-in images are orientated along the longer axis of the boxed regions. Scale bars, 1 micrometer (FIGS. 8A, 8B, 8G, 8H); 200 nm (FIGS. 8C-8F, 8I, 8J).

Image alignment and channel registration. Prior to imaging, an alignment between the two channels (L and R) was performed. In brief, 100 nm fluorescent microspheres (TetraSpeck, Invitrogen) were immobilized on the surface of a glass coverslip at a density of ˜0.2 microspheres/micrometer². Each imaging field of view contained more than 100 beads. Starting from the focal plane, the sample was sequentially displaced in 100 nm increments over a range of slightly more than 3 micrometers while images of the beads in both channels were recorded for each z position of the sample to generate an image trajectory for each bead. A new region was then chosen and the whole process was repeated 10 times. Images of all 10 regions were then superimposed onto each other to create an image with a high density of fiducial markers within the imaging volume. Multiple steps of third-order polynomial transformations were used to correct for aberration in each of the L and R channels such that the bead images in the two channels were identical to each other at any z position of the bead sample, but with exactly anti-symmetric z-dependent lateral bending (FIG. 9). For each channel, these multiple steps of third-order polynomial transformations were combined into a single transformation matrix, which was called the channel alignment matrix and was later used for analysis of individual frames of images in STORM movies. The calibration curve for the lateral bending as a function of the axial position (shown in FIG. 1E) was also generated in this process as each bead was imaged for many axial positions. Because the lateral bending was anti-symmetric in the L and R channels after the channel alignment procedure, the x and y positions of the beads did not move appreciably as the sample was translated along the axial direction (FIG. 1F).

Single-molecule and STORM imaging. All imaging was performed in a solution that contained 100 mM Tris (pH 8.0), an oxygen scavenging system (0.5 mg/mL glucose oxidase (Sigma-Aldrich), 40 microgram/mL catalase (Roche or Sigma-Aldrich) and 5% (w/v) glucose) and 143 mM beta-mercaptoethanol. For 647 nm illumination, an intensity of 2 kW/cm² was used. Under this illumination condition, all dye molecules were typically in the fluorescent state initially but rapidly switch to a dark state. All STORM movies were recorded at a frame rate of 50 Hz using home-written Python-based data acquisition software. The movie recording was started once the majority of the dye molecules were switched off and individual fluorescent molecules were clearly discernible. The movies typically had 30,000 to 100,000 frames. During each movie, a 405 nm laser light (ramped between 0.1-2 W/cm2) was used to activate fluorophores and to maintain a roughly constant density of activated molecules. In STORM imaging of in vitro microtubules, a weak 561 nm laser (˜20 W/cm²) was used to illuminate fiducial markers.

STORM image analysis. Single-molecule and STORM movies from the two channels, L and R, (recorded on the left and right halves of the same camera) were first split and individually analyzed. For single-molecule and in vitro microtubule imaging, fiducial markers were used for sample drift correction, while for cellular imaging, correlation between images taken in different time segments was used for drift correction. Channel alignment matrices derived for the L and R channels from the bead sample were then applied to drift-corrected molecule localizations, resulting in molecule lists in each channel (x_{Lmol}, y_{Lmol}) and (x_{Rmol}, y_{Rmol}), respectively. Molecule images in the two channels were linked as arising from the same molecule if they fulfilled the following three criteria: 1) their separation along the x-dimension, which is the direction of bending of the SB-PSF, is less than the maximum bending distance (typically 0<x_{Rmol}−x_{Lmol}<5 micrometers); 2) their separation along y-dimension was less than the size of a single pixel (140 nm); and 3) they both appeared and disappeared in the same frame. In addition, those molecules that appeared to have more than one pairing candidates in the other channel were rejected to avoid ambiguity. After linking, the lateral position (x, y) of the molecule was determined using x=(x_{Lmol}+x_{Rmol})/2 and y=(y_{Lmol}+y_{Rmol})/, while the axial position z was determined from Δx=(x_{Rmol}−x_{Lmol})/2 using the calibration curve shown in FIG. 1E, followed by a correction for refractive index mismatch between oil/glass and the imaging medium.

Numerical simulation. The simulation of SB-PSF was performed using a partially coherent emission beam consisting of 256 independent spatial modes, each of which was a plane-wave composite of a Gaussian wavepacket. Each mode was first modulated by the phase pattern on the SLM as described above and FIG. 6. The Fourier transform of these modes was then propagated using a linear split-step Fourier algorithm. At each step (propagation length), the overall beam intensity was computed as incoherent sum of individual mode intensities. The simulation of a standard Gaussian PSF started with the exact Airy-disk expression, which was then propagated using the same split-step Fourier algorithm. A detailed procedure of the simulations is described below.

Below are discussions concerning numerical simulations for propagations of SB-PSF and Gaussian PSF. The numerical simulation of beam propagation is based on the paraxial wave equation:

$$i \frac{\partial U}{\partial z} + \frac{1}{2 k} ( \frac{{\partial }^{2} U}{\partial {x}^{2}} + \frac{{\partial }^{2} U}{\partial {y}^{2}} ) = 0 , \qquad ( 1 )$$

where U(x, y, z) is the slowly-varying wave field, k is the wavenumber, and z and (x, y) represents axial and lateral coordinates, respectively. In practice, the initial wave field U(x, y, 0) at z=0 was first defined as either the sum of individual spatial modes for the SB-PSF or the Airy-disk solution for the Gaussian PSF. The propagation of these wave fields was calculated in Fourier space using a linear split-step algorithm over the distance determined by experimental settings, which was then inverse-Fourier transformed to construct the final wave field. Detailed procedures are described below.

For SB-PSF, because fluorescence emission was partially coherent, the incoming wavepacket W(k_{⊥}) onto the SLM was decomposed into 256 plane-wave composites Wₘ(k_{⊥})=exp(imk_) (m=1, 2, . . . , 256), orienting at different angles enveloped by a Gaussian wavepacket to form

$$W ( {k}_{⊥} ) = {\sum }_{m} exp ( - {k}_{⊥}^{2} ) {W}_{m} ( {k}_{⊥} ) ,$$

where k, represents lateral spatial frequency coordinates kₓ and k_{y}. These individual spatial modes were then multiplied by the cubic phase, exp(i[(kₓ+k_{y})³+(−kₓ+k_{y})³]) and truncated by a rectangular function rect(k_{yc}) in the k_{y} direction at |k_{y}|=k_{yc}. The wave field H at the SLM is then:

(k_{⊥})=W(k_{⊥})exp(i[(kₓ+k_{y})³+(−kₓ+k_{y})³])rect(k_{yc}), (2)

where rect(k_{yc}) describes the spatial apodization shown in FIG. 6. Propagated by the imaging lens RL2 shown in FIG. 5, the wave field U(x, y,0) on the image plane (EMCCD, FIG. 5) is the Fourier transform of H:

U(x,y,0)=FT(H(k_)) (3)

For the Gaussian PSF, the wave function for a Gaussian PSF U(x, y,0) is described by the exact Airy disk solution U(x, y,0) =Bessel(r)Ir , where Bessel(r) represents the Bessel function of the first kind as a function of radial coordinate r.

The propagation of wave field U(x, y, z) with the initial wave functions U(x, y,0) was calculated by the split-step algorithm. S pecifically, for SB-PSF, mode interactions between individual composites were ignored in light of the incoherence of fluorescence emission. Hence, individual composites were propagated and computed independently and the overall beam intensity was obtained as the incoherent sum of individual intensities. For Gaussian PSF, U(x, y, z) was described by the propagation of the exact Airy disk wave function U(x, y,0).

Eq. (1) gives:

$$\frac{\partial U}{\partial z} = i \frac{1}{2 k} ( \frac{{\partial }^{2} U}{\partial {x}^{2}} + \frac{{\partial }^{2} U}{\partial {y}^{2}} ) = i \frac{1}{2 k} {∇}_{⊥}^{2} U . \qquad ( 4 )$$

Calculating the Fourier transform of both sides of the wave equation (4) leads to:

$$\frac{\partial \tilde{U}}{\partial z} = i \frac{1}{2 k} {( i 2 π {k}_{⊥} )}^{2} \tilde{U} = - i \frac{1}{2 k} {( 2 π {k}_{⊥} )}^{2} \tilde{U} , \qquad ( 5 )$$

where Ũ(k_{⊥}, z) is the Fourier transform of U(x, y, z). Integrating in Fourier space over a small step dz then leads to:

$$\tilde{U} ( {k}_{⊥} , z + dz ) = exp ( - i \frac{1}{2 k} {( 2 π {k}_{⊥} )}^{2} dz ) \tilde{U} ( {k}_{⊥} , z ) . \qquad ( 6 )$$

The term

$$exp ( - i \frac{1}{2 k} {( 2 π {k}_{⊥} )}^{2} dz )$$

determines the evolution of the wave field in the Fourier space at every step of propagation. The process was repeated over the desired distance.

At any propagation distance z+dz, the wave field in the spatial domain U is then the

inverse Fourier transform of Ũ.

Lateral bending of the SB-PSF. According to the model of a coherent Airy beam, the bending trajectory is described as:

$$Δ {x}^{′} = {Az}^{′2} = \frac{1}{2 \sqrt{2} {k}^{2} {x}_{0}^{′3}} {z}^{′2} , \qquad ( 7 )$$

where Δx′ and z′ are lateral bending and axial propagation distance, respectively, of the beam measured in terms of coordinates on the image plane, A is the bending coefficient, k=2π/λ is the wavenumber and x′₀ describes the size of the main lobe. The full width at half maximum (FWHM) of the intensity profile of the main lobe of is 1.6 x′₀. (Δx′, z′) may be easily related to the coordinates on the object plane (Δx, z) using x′₀=Mx₀, Δx′=MΔx, and z′=M²z, where M is the magnification of the imaging system. Hence:

$$Δ x = \frac{1}{2 \sqrt{2} {k}^{2} {x}_{0}^{3}} {z}^{2} . \qquad ( 8 )$$

In these experiments, with z=3 micrometers, k=2π/700 nm=9 μm⁻¹, x₀≈250 nm, the lateral bending Δx is estimated to be 2.53 micrometers. The experimental observation of Δx=(x_{R}−x_{L}/2=2.45 μm (FIG. 1E) matches well with this predicted value.

The photon detection efficiency related to the SLM. Photon losses were measured due to the use of SLM by imaging fluorescence microspheres. It was and found that implementation of the SB-PSF using the truncated cubic phase pattern on the SLM reduced the number of detected photons to ˜2000, which is ˜35-40% of the value (5000-6000 photons for Alexa 647 per switching cycle) obtained when the SLM is not used. The losses originated from two sources. Phase wrapping on the pixelated SLM resulted in multiple orders of diffraction, where only the first-order diffraction was used.

The unmodulated (zeroth-order) light contributed to a ˜50% photon loss. Higher-order diffractions were negligible. Removal of side-lobes by the additional phase modulation (See FIGS. 6 and 7) caused additional photon loss and, as a result, 70-80% of the remaining 50% of light were retained. Methods to improve photon efficiency are discussed above.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used.

Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A system for microscopy, comprising:
an illumination system comprising an excitation light source directed at a sample region;
a spatial light modulator for altering light produced by an emissive entity in the sample region to produce an Airy beam;
a detector for receiving light altered by the spatial light modulator; and
a controller for controlling light produced by the illumination system, wherein the controller is able to repeatedly or continuously expose the sample region to excitation light from the excitation light source.

2. The system of claim 1, further comprising a polarizing beam splitter for polarizing the light produced by the emissive entity.

3. The system of claim 2, wherein the polarizing beam splitter produces a first polarized beam and a second polarized beam, the first polarized beam and the second polarized beam having substantially orthogonal polarizations.

4. The system of claim 3, wherein the spatial light modulator is able to alter the first polarized beam and the second polarized beam, and the detector is able to receive the altered first polarized beam and the altered second polarized beam from the spatial light modulator.

5. The system of claim 4, wherein the spatial light modulator displays two patterns substantially centered around each of the polarized beams.

6. The system of claim 1, wherein at least a portion of the spatial light modulator displays a cubic phase pattern.

7. The system of claim 1, wherein at least a portion of the spatial light modulator displays a diffraction grating.

8. (canceled)

9. The system of claim 1, wherein at least a portion of the spatial light modulator is configured to reduce formation of a side lobe on the Airy beam.

10. The system of claim 1, wherein the spatial light modulator comprises an electrically addressed liquid crystal display.

11. The system of claim 1, wherein the spatial light modulator comprises an optically addressed spatial light modulator.

12-13. (canceled)

14. The system of claim 1, wherein the excitation light source substantially monochromatic.

15. The system of claim 1, wherein the illumination system further comprises an activation light source able to produce activation light.

16-96. (canceled)

97. An imaging method, comprising:
converting light emitted by emissive entities in a sample to produce one or more light beams, wherein the positions of the light beams depends on propagation distance;
acquiring one or more images of the light beams; and
determining the positions of at least some of the emissive entities within the sample based on the one or more images.

98. The method of claim 97, comprising polarizing the light emitted by the emissive entities into two polarization beams having substantially orthogonal polarizations.

99. The method of claim 98, comprising directed the light emitted by the emissive entities at a polarizing beam splitter.

100. The method of claim 97, comprising altering phasing of the polarized light using the spatial light modulator.

101. The method of claim 97, where converting light emitted by emissive entities in a sample to produce one or more light beams, wherein the positions of the light beams depends on propagation distance, comprising using a spatial light modulator.

102. The method of claim 101, wherein the spatial light modulator displays two patterns substantially centered around each of the light beams.

103-108. (canceled)

109. The method of claim 101, wherein at least a portion of the spatial light modulator displays a pattern able to convert incident light thereto into an Airy beam.

110-116. (canceled)

117. The method of claim 97, comprising acquiring the one or more images using a stochastic imaging technique.

118-189. (canceled)
